(19) United States
(12) Patent Application Publication
(10) Pub. No.: US 2022/0026059 A1
(43) Pub. Date: Jan. 27, 2022

(54) PULSATING COMBUSTION DEVICE WITH IMPROVED ENERGY CONVERSION EFFICIENCY AND REDUCED NOISE LEVEL

(71) Applicant: IIgiz Yamilev, Moscow (RU)

(72) Inventors: Ilgiz YAMILEV, Moscow (RU); Andrey Alekseevich VAKUTIN, Moscow (RU)

(73) Assignee: IIgiz Yamilev, Moscow (RU)

(21) Appl. No.: 17/298,151

(22) PCT Filed: Dec. 6, 2018
(86) PCT No.: PCT/RU2018/000791

§ 371 Date: May 28, 2021

(51) Int. Cl. F23C 15/00; G10K 11/04; G10K 11/172; G10K 11/16

(52) U.S. Cl. CPC F23C 15/00; G10K 11/04; F23C 2205/00; G10K 11/161; G10K 11/172

(57) ABSTRACT

This invention refers to the energy sector and can be applied in heating systems, in particular in water heaters or boilers; in disposal systems operating on associated gas flaring. The pulsating combustion device comprises a combustion chamber and, connected thereto, an air and fuel gas supply unit and a flue duct. Said flue duct comprises at least one resonance pipe connected to the combustion chamber and at least two Helmholtz resonators located successively downstream of the at least one resonance pipe. Each of said resonators consists of a flue chamber and a flue pipe arranged downstream thereof, and natural resonance frequency of each of the Helmholtz resonators is less than combustion pulsation frequency. The invention allows to increase the pulsating combustion device efficiency with a simultaneous reduction of the noise level.

### FIELD OF THE INVENTION

This invention refers to the energy sector and can be applied in heating systems, in particular in water heaters or boilers; in disposal systems operating on associated gas flaring; in the electric energy generation systems.

### BACKGROUND OF THE INVENTION

Pulsating combustion devices with combustion chamber, ignition unit, fuel inlet and air input devices, exhaust ducts discharging combustion residues are widely known. Such devices are highly efficient but produce a lot of noise and oscillation. Some measures are being taken to improve efficiency and reduce noise and oscillation. The issue of efficiency improvement combined with the problem of noise and oscillation reduction in pulsating combustion devices has been solved differently.

There are mufflers for pulsating gas flow compressors and similar devices. U.S. Pat. No. 2,943,641 patent describes a muffler using Helmholtz resonators, the muffling ratio depends on the correlation between noise and resonator's frequencies.

According to U.S. Pat. No. 4,639,208, sound-absorbing materials are installed on the section from the combustion chamber to the filter check valve to reduce the noise level.

According to U.S. Pat. No. 4,259,928, in the air supply duct of the pulsating combustion device, there is a muffler coupled with an air check valve, besides this muffler is inside an enclosing cavity located in a vessel filled with water. There is also a muffler in the flue gas duct.

According to U.S. Pat. No. 4,477,246, a pulsating combustion device comprises a muffler on the air supply and an exhaust gas muffler made in one housing and comprising outer and inner cylinders divided into chambers to retain low and high frequency sounds.

According to U.S. Pat. No. 4,475,621, in a pulsating combustion device, an air valve enclosure is covered with a sound-absorbing material, and an exhaust flue gas duct is equipped with a gas-gas type heat exchanger.

According to U.S. Pat. No. 5,020,987, a pulsating combustion device uses an advanced mechanical gas check valve to reduce amplitude of pressure fluctuations in a combustion chamber in order to reduce the noise level.

The closest device to the proposed one is a pulsating combustion device as per the U.S. Pat. No. 4,919,085, including a muffler comprising two chambers connected by a pipe, the muffler is installed in a flue gas exhaust duct. In order to improve the efficiency of the pulsating combustion device and to reduce the noise level, these chambers are placed in a vessel with a coolant. The muffler is installed in the air supply duct, one side of the muffler connected to a fan, while the other side is connected to an air chamber that encloses an air valve and has inner and outer walls, and the space between the walls is filled with sand.

The above solutions help insignificantly to improve the device efficiency; other solutions implemented help to reach extra efficiency which is much higher. Also, the implementation of the above solutions does not allow obtaining necessary level of noise suppression and oscillation reduction.

### SUMMARY OF THE INVENTION

The invention solves the technical problem by the pulsating combustion device efficiency improvement with a simultaneous reduction of the noise level.

The technical problem is solved by a pulsating combustion device that comprises a combustion chamber and, connected thereto, an air and fuel gas supply unit and a flue duct, said flue duct comprising at least one resonance pipe connected to the combustion chamber and at least two Helmholtz resonators located successively downstream of the at least one resonance pipe, each of said resonators consisting of a flue chamber and a flue pipe arranged downstream thereof, and natural resonance frequency of each of the Helmholtz resonators is less than combustion pulsation frequency.

There may be an embodiment wherein there are at least three said Helmholtz resonators of which at least one Helmholtz resonator is connected to the flue chamber of the third downstream Helmholtz resonator by means of a second flue pipe bypassing the next downstream Helmholtz resonator.

There also may be an embodiment wherein at least one resonance pipe is connected to the first Helmholtz resonator through a low-pass acoustic filter having a cut-off frequency higher than the combustion pulsation frequency.

Moreover, the flue chamber of at least one of the Helmholtz resonators may be divided into two cavities by a partition with an opening or slot having an area larger than the total area of through cross-sections of the resonance pipes.

There may be an embodiment wherein an element with resistive and/or inductive impedance to gas flow is installed in the flue channel upstream or downstream of the flue chamber of at least one Helmholtz resonator.

In this case, the element with resistive impedance to gas flow may be a filter screen.

In another embodiment, the element with resistive impedance to gas flow may be a gas-gas type heat exchanger.

In addition, the element with inductive impedance may be a turbine, or a fan, or a reversible device that can operate both as a fan and as a turbine.

In this case, in one embodiment, a turbine, or a fan, or a reversible device that can operate both as a fan and as a turbine, is installed in the flue chamber of the at least one Helmholtz resonator.

In another embodiment, a turbine or fan, or a reversible device that can operate both as a fan and as a turbine, is installed upstream or downstream of the flue chamber of the at least one Helmholtz resonator.

There may be an embodiment where a quarter-wave resonator or a Helmholtz resonator with natural resonance frequency equal to frequency of combustion pulsations is connected to the flue chamber of the at least one Helmholtz resonator in the flue duct.

In the preferred embodiment, the air and fuel gas supply unit has at least one check valve.

If air and fuel gas are fed separately to the combustion chamber, the air and fuel gas supply unit includes at least one air check valve connected to an air duct and at least one combustible gas check valve connected to a fuel gas duct.

In this case, it is reasonable to equip the air duct with at least one enclosure chamber with the at least one air check valve inside and an air supply pipe connected to the enclosure chamber forming a first air duct Helmholtz resonator.

It is preferable that walls of the enclosure chamber of the at least one air check valve are coated with sound-absorbing material on the inside and/or outside.

Besides, the air duct may comprise additionally at least one successively connected Helmholtz resonator having natural resonance frequency less than the combustion pulsation frequency.

In this case, the pipes of the air duct Helmholtz resonators may be located inside the pipes of the flue duct Helmholtz resonators.

Moreover, it is preferable to locate the Helmholtz resonators of the flue and air ducts in the same housing.

Besides, an element with resistive impedance to gas flow can be installed in the air duct.

In this case, the unit with resistive impedance to gas flow may be a filter screen.

There may be an embodiment wherein a fan, a turbine, or a reversible device is installed in the chamber of the at least one air duct Helmholtz resonator, said reversible device being able to operate as a fan during purging and as a turbine when the combustion chamber is in operation.

There may be an embodiment wherein the chamber of the at least one air duct Helmholtz resonator is divided into two cavities by a partition with an opening or slot having an area greater than the area of a through cross-section the resonance pipe, if there is one resonance pipe, or greater than the total area of through cross-sections of the resonance pipes.

There may be different options for connecting the air duct and the flue gas duct to the combustion chamber.

In one embodiment, the at least one air check valve and the at least one fuel gas check valve are connected to the combustion chamber by first and second branch pipes, respectively, the axis of the first branch pipe is angled to the combustion chamber wall and inclined toward the second branch pipe, while the second branch pipe is connected to the combustion chamber through openings and/or slots, and there is a partition at the first branch pipe outlet that separates the first branch pipe outlet from the second branch pipe outlet.

In another embodiment, the at least one air check valve is connected to the combustion chamber by a third branch pipe at the outlet of which a guide unit is installed in the combustion chamber to divert the air flow along the combustion chamber wall, and the at least one fuel gas check valve is connected to the combustion chamber by a fourth branch pipe, said fourth branch pipe is connected to the combustion chamber through openings and/or slots located along the air flow from the guide unit.

In a third embodiment, at least one air check valve is connected to the combustion chamber by a fifth branch pipe, wherein at least one blade is installed at the outlet to the combustion chamber, the blade partially overlaps the air supply duct, at the same time, the fifth branch pipe is enclosed by an annular fuel gas chamber connected to the combustion chamber through an annular slot and connected to the at least one fuel gas check valve; a guide unit is installed at the outlet of the annular slot and inclined towards the air supply duct outlet.

In another embodiment, the at least one air check valve is connected to the combustion chamber by a sixth branch pipe with at least one blade installed at the combustion chamber inlet, the blade partially overlaps the air supply duct, the at least one fuel gas check valve is connected to the combustion chamber through a respective transition chamber adjacent to the sixth branch pipe and connected to the combustion chamber through a slot at the outlet of which there is at least one guide element inclined to the outlet of the sixth branch pipe.

If the combustion chamber is fed with a ready combustible mixture, the air and fuel gas supply unit includes a combustible mixture check valve connected to the combustion chamber by a seventh branch pipe that contains a flame arrestor with passageways with the inner diameters smaller than the passageways length.

At least one of the above check valves may be a mechanical check valve.

Furthermore, a shock wave damper may be installed at the inlet and/or outlet of at least one of the above check valves.

At the same time, it is preferably that the shock wave damper is an acoustic low-pass filter with a cut-off frequency higher than the combustion pulsation frequency.

Moreover, the shock wave damper at the inlet and/or outlet of the air check valve can be a duct bend at the inlet and/or outlet of the air check valve.

Alternatively, the shock wave damper can be a solid or perforated screen.

Also, a oscillation isolator may be installed between at least one of the above check valves and the combustion chamber.

Moreover, a oscillation isolator may be installed between at least one check valve with an acoustic filter and the combustion chamber, and at least one said check valve is secured in a required position in space by elastic means.

### LIST OF DRAWINGS

The invention is illustrated by drawings.

FIG. 1 shows the proposed pulsing combustion device with separate air and combustible gas supply.

FIG. 2—scaled-up area A from FIG. 1.

FIG. 3—a part of the pulsating combustion device with the combustible mixture pre-conditioning.

FIG. 4—a dynamic air check valve.

FIG. 5—the pulsating combustion device with the transfer of heat energy from the flue duct to the air stream.

FIG. 6—an oscillating parallel circuit—an analogue of the Helmholtz resonator.

FIG. 7—a graph of dependence between amplitude of flow rate fluctuations in Helmholtz resonator pipes to the amplitude of flow rate fluctuations at the inlet to Helmholtz resonator and quality of Helmholtz resonator and ratio of flow rate fluctuations frequency to the natural frequency of the Helmholtz resonator.

FIG. 8—graph of dependence, in decibels, between amplitude of flow rate fluctuations at the Helmholtz resonator inlet to the amplitude of flow rate fluctuations in the pipes and quality of Helmholtz resonator and ratio of flow rate fluctuations frequency to the natural frequency of the Helmholtz resonator.

FIG. 9—an acoustic low-pass filter at the resonance pipes output.

FIG. 10—the pulsating combustion device with an element with inductive impedance at the inlet to the first flue chamber outside the chamber.

FIG. 11—the same, with an element with inductive impedance at the inlet to the first flue chamber inside the chamber.

FIG. 12—the same, with an element with inductive impedance at the outlet of the first flue chamber outside the chamber.

FIG. 13—the same, with an element with inductive impedance at the outlet of the first flue chamber inside the chamber.

FIG. 14—the pulsating combustion device with several successively connected Helmholtz resonators in the flue and air ducts.

FIG. 15—the pulsating combustion device with an element with inductive impedance at the inlet to the successive flue chamber outside the chamber.

FIG. 16—the same, with an element with inductive impedance at the inlet to the successive flue chamber inside the chamber.

FIG. 17—the same, with an element with inductive impedance at the successive flue chamber outlet outside the chamber.

FIG. 18—the same, with an element with inductive impedance at the first flue chamber inside the chamber.

FIG. 19—a graph of variation of pressure P in the combustion chamber in time t with the increase in energy of pressure fluctuations in the time interval T.

FIG. 20—a graph of variation of pressure P in the combustion chamber in time t with the decrease in the energy of pressure fluctuations in the time interval T.

FIG. 21—a graph of variation of pressure P in the combustion chamber in time t with the initiation of combustion at the moment t₁ (solid line) and without combustion (dashed line).

FIG. 22—a graph of variation of pressure P in the combustion chamber in time t at different values of the average pressure in the combustion chamber.

FIG. 23—an unit for combustible mixture preparation with separate air and fuel gas supply and a partition for turbulence, side view.

FIG. 24—the same as in FIG. 23, top view.

FIG. 25—the same as in FIG. 23, perspective view of the combustion chamber end wall.

FIG. 26—a unit for combustible mixture preparation with separate air and fuel gas supply and a guide unit, side view.

FIG. 27—the same as in FIG. 26, top view.

FIG. 28—the same as in FIG. 26, perspective view of the combustion chamber end wall.

FIG. 29—a unit for combustible mixture preparation with separate air and fuel gas supply and blades, side view.

FIG. 30—the same as in FIG. 29, top view.

FIG. 31—the same as in FIG. 29, perspective view of the combustion chamber end wall.

FIG. 32—a unit for combustible mixture preparation with separate air and fuel gas supply and blades and check valves, side view.

FIG. 33—the same as in FIG. 32, B-B section.

FIG. 34—a gas check valve plate.

FIG. 35—flue duct Helmholtz resonators connected bypassing the successive downstream resonator.

### EXAMPLES OF PREFERRED EMBODIMENTS OF THE INVENTION

The pulsating combustion device comprises a combustion chamber 1 with a connected unit that supplies air and fuel gas with a connected flue duct that comprises at least one resonance pipe 2 connected to the combustion chamber 1 and at least two Helmholtz resonators 3 and 4 located successively after at least one resonance pipe 2, each of said resonators 3 and 4 consists of a flue chamber 5 and 6 and a flue pipe 7 and 8 after it, the natural resonance frequency of each of the Helmholtz resonators 3 and 4 is lower than the combustion pulsation frequency.

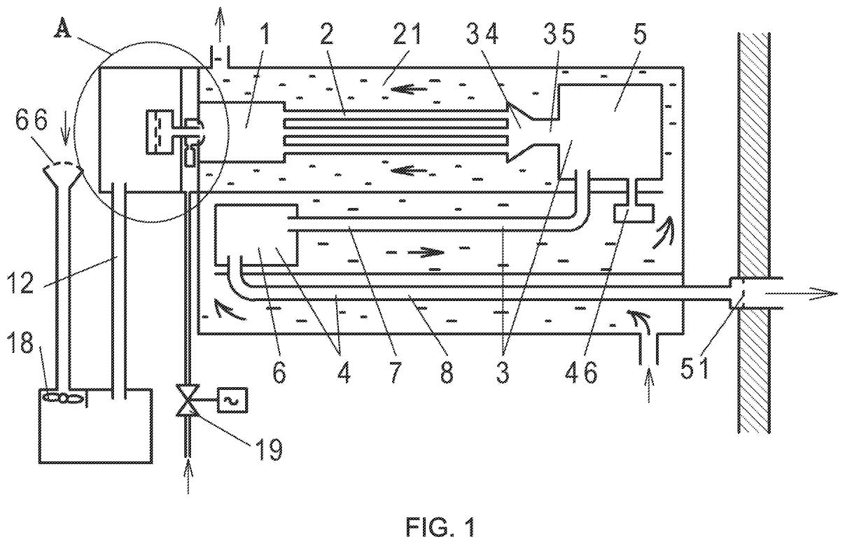

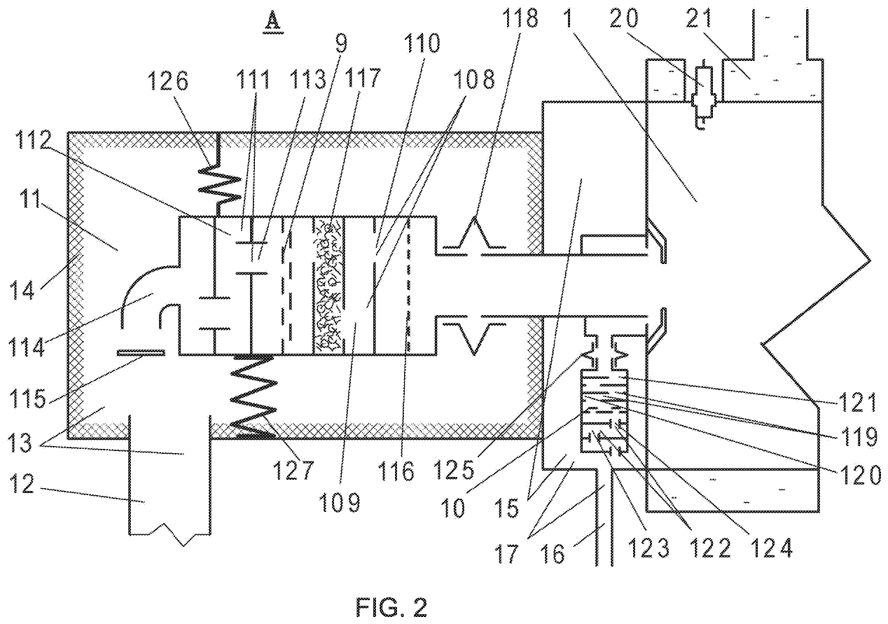

FIGS. 1 and 2 show an embodiment of the pulsating combustion device with a separate supply of fuel gas and air to the combustion chamber 1. The device comprises a combustion chamber 1 connected to the air and fuel gas supply unit on one side and a flue duct on the other side. In the embodiment shown on FIGS. 1 and 2, the air and fuel gas supply unit includes an air check valve 9 connected to the air duct, and a fuel gas check valve 10 connected to the fuel duct, the flue duct comprising at least one resonance pipe 2 connected to the combustion chamber 1. FIG. 1 shows several resonance pipes 2 connected in parallel with the combustion chamber 1, then at least two Helmholtz resonators 3 and 4 are located successively, each of the resonators are arranged by the flue chamber 5, 6 and the flue pipe 7, 8 located after it, respectively.

FIG. 2 shows the air duct that has an enclosure chamber 11 with an air check valve 9 located inside, and an air supply pipe 12 connected to the enclosure chamber 11, which, in turn, arrange the Helmholtz resonator 13 as well. The enclosure chamber 11 can be coated with a sound-absorbing material 14 on the inside and/or outside. The fuel gas duct comprises the enclosing chamber 15 with a fuel gas check valve 10 located inside, and a fuel gas supply pipe 16 connected to the enclosing chamber 15, which, in turn, arrange the Helmholtz resonator 17 as well.

The device illustrated in FIG. 1 and FIG. 2 operates as follows. The fan 18 delivers air through the air supply pipe 12 into the enclosure chamber 11 of the air check valve 9, ensures purging of the combustion chamber 1 and the air for ignition of the combustion chamber 1 flows into the combustion chamber 1 through the air check valve 9 and flows through the resonance pipes 2 into the flue duct. When the solenoid valve 19 is opened, fuel gas enters the combustion chamber 1 through the fuel gas check valve 10. When fuel gas is mixed with air, a combustible mixture is created, this mixture is ignited by the spark plug 20. During combustion, the pressure in the combustion chamber 1 rises. The pressure in the combustion chamber 1 makes the products of combustion move through the resonance pipes 2 from the combustion chamber 1 with acceleration proportional to the pressure in the combustion chamber 1. At the same time, the flue gas flow rate in the resonance pipes 2 increases, and the pressure in the combustion chamber 1 drops. When the pressure in the combustion chamber 1 aligns with the flue duct pressure in the resonance pipes 2, the combustion products flow accelerates, and this way completes the conversion of the pressure potential energy in the combustion chamber 1 into the flow kinetic energy in the resonance pipes 2. The momentum will move the combustion products in the resonance pipes 2 to produce underpressure effect in the combustion chamber 1. The underpressure in the combustion chamber 1 opens the check valves 9 and 10, and the combustion chamber 1 is fed by air and fuel gas, which, mixed together, generate a combustible mixture ignited by hot gases of combustion products. The pressure in the combustion chamber 1 rises, and the working cycle of the combustion chamber 1 recurs. Since the air in the combustion chamber 1 is supplied by underpressure, and the combustion mixture is ignited by hot combustion products, the fan 18 and the spark plug 20 are switched off from the power supply, but the fan 18 can continue spinning by the air flow supplied for combustion. The combustion chamber 1 and resonance pipes 2 are placed in a coolant, for example, in a water vessel 21.

As a rule, combustion products need to be released far away from the pulsating combustion device. Flue gas ducts are used for this end. The flue gas ducts can contain different elements and devices, such as a turbine or fan, gas-gas type heat exchanger, turns, cross-sectional area modifications, cross-sectional shape modifications, mesh filters, shut-off damper, oscillation absorbers.

The pulsating combustion devices may have different embodiments distinguished by the way the combustible mixture is generated, by the types of check valves used, by the way heat energy is released.

FIGS. 1 and 2 show an embodiment with a separate supply of air through a mechanical air check valve 9 and fuel gas through a mechanical fuel gas check valve 10 into the combustion chamber 1.

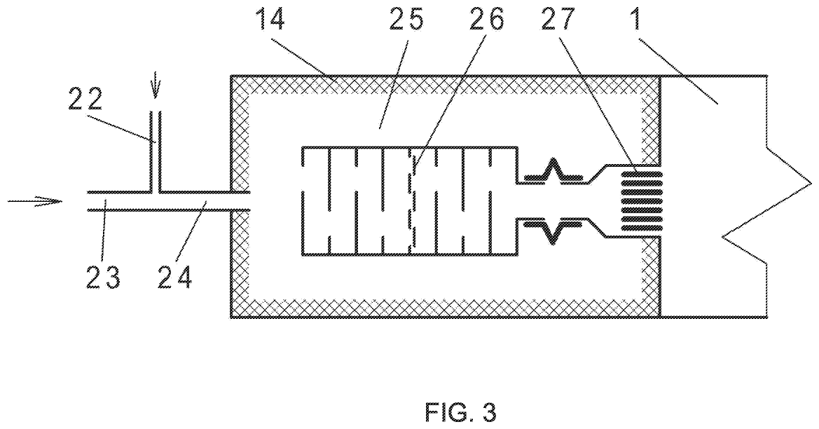

FIG. 3 illustrates an embodiment with the combustible mixture pre-conditioning. Fuel gas passes into the air flow that moves in the duct 23 through the duct 22. The combustible mixture flows into the prepared combustible mixture chamber 25 through the duct 24. The combustible mixture flows into the combustion chamber 1 through the check valve 26 and the flame arrestor 27 equipped with passageways with diameters smaller than the duct length.

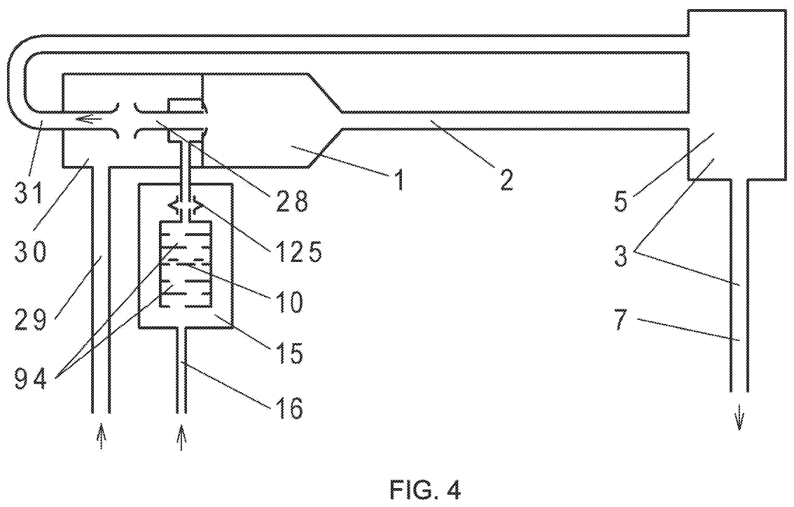

FIG. 4 shows a dynamic air check valve 28. Air flows into the air chamber 30 through the duct 29 and then enters the combustion chamber 1 through the dynamic check valve 28. Return flue gases are diverted through the duct 31.

FIG. 1 demonstrates an option of transmission of thermal energy to water by the combustion chamber 1, resonance pipes 2 and flue duct Helmholtz resonators 3, 4.

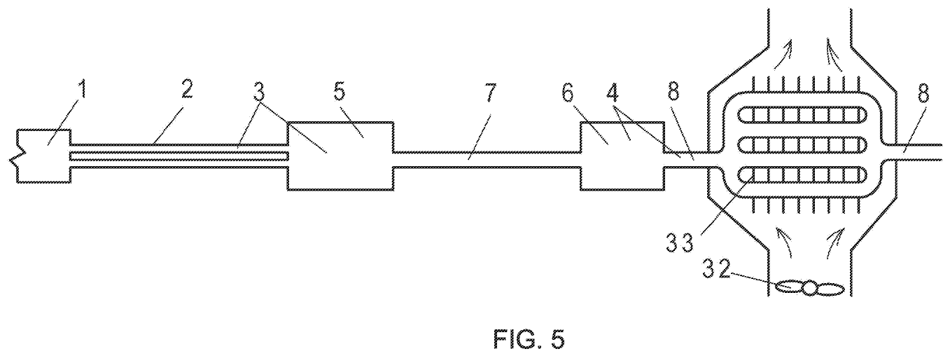

FIG. 5 shows the transmission of thermal energy to the air flow generated by the fan 32 through the gas-gas type heat exchanger 33 from the pipe 8 of the flue duct Helmholtz resonator 4 arranged by the chamber 6 and the pipe 8.

In the main embodiment, several resonance pipes 2 can be combined into a single pipe at the outlet. FIG. 1 shows an implementation of the pulsating combustion device with multiple resonance pipes 2 connected to a small chamber 34 by their outputs, the chamber 34 is connected to the flue chamber 5 of the first Helmholtz resonator 3 by a coupling pipe 35.

The combustion chamber 1 and the resonance pipes 2 arrange a Helmholtz resonator. Usually, a Helmholtz resonator comprises a chamber and one pipe. If there are several resonance pipes 2 in the pulsating combustion device, the properties of this resonator generated by the combustion chamber 1 and the resonance pipes 2 match the properties of a resonator generated by the same chamber and one pipe with the cross-sectional area equal to the cross-sectional area of the resonance pipes 2 and the pipe length equal to the length of the resonance pipes 2. Some properties of a Helmholtz resonator that are essential for the invention description are specified for the one pipe resonator. For a resonator with several pipes, the cross-sectional area of the pipe is considered equal to the total cross-sectional area of all resonator pipes.

As is commonly known, natural frequency of a Helmholtz resonator is:

$${f}_{0} = \frac{c}{2 π} \sqrt{\frac{A}{V l}} \qquad ( 1 )$$

where f₀ is the natural resonance frequency, Hz,
c—velocity of sound, m/see,
A—cross sectional area of the pipe, the sum of the cross sectional areas of the pipes for several pipes, m²,
V—chamber volume, m³,
l—length of each pipe, in.

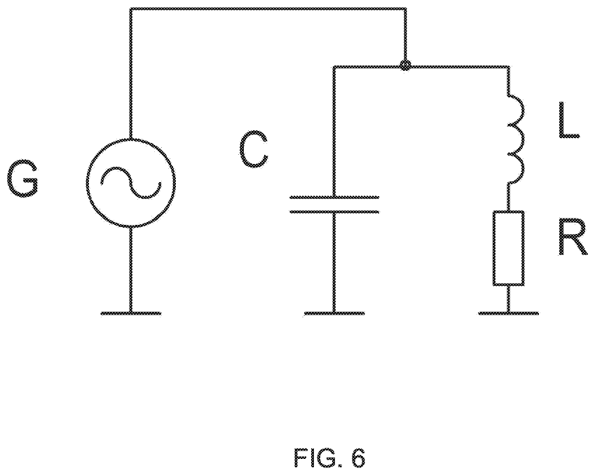

In electrical engineering, the oscillating circuit properties are well researched, and properties of a Helmholtz resonator are similar to the properties of an oscillating circuit. An analog of a Helmholtz resonator is a parallel oscillating circuit illustrated in FIG. 6 where G is an ideal alternator with output current independent of resistance at the oscillator output.

The chamber has properties of acoustic capacitance equal to:

$$C = \frac{V}{γ \cdot {P}_{0}} \qquad ( 2 )$$

where C is the acoustic capacitance, m³/Pa,
γ—adiabatic coefficient,
P₀—average chamber pressure, Pa,
V—chamber volume, m³.

The pipe has an acoustic inductance property equal to:

$$L = \frac{ρ \cdot l}{A} \qquad ( 3 )$$

where L is the acoustic inductance, Pa·sec²/m³,
ρ—density of gas in the pipe, kg/m³,
l—pipe length, m,
A—cross sectional area of the pipe, the sum of cross sectional areas of the pipes for several pipes, m².

The formula does not assume the gas compressibility and velocity of sound. The gas compressibility in the pipe leads to increase in acceleration of gas flow at the pipe inlet, which is equivalent to decrease in real acoustic inductance. With a long pipe length, the gas velocities at the inlet and outlet differ, at the beginning of the pipe not all of the gas mass in the pipe impacts the flow acceleration at the beginning of the pipe, so the actual acoustic inductance of the pipe is lower. When the pipe length is proportional to wavelength of gas flow fluctuations in the pipe, the phase of gas flow fluctuations along the pipe is significantly different, so the effective acoustic inductance greatly differs from the calculated value, so that this pipe cannot make a Helmholtz resonator with a chamber connected to it.

In the resonance pipes 2 of the pulsating combustion device, the temperature of the combustion products varies along the pipe 2, and in the pulsating combustion device in some operating modes condensate falls out of the combustion products in the resonance pipes 2, so the density and flow rate of combustion products along the resonance pipes 2 are different. In order to simplify the argument, let us assume that density and velocity of the combustion products in the resonance pipe 2 is identical along the entire length of the resonance pipe 2.

The Helmholtz resonator chamber resistance with acoustic capacitance C to oscillations with frequency f is equal to:

$${X}_{C} = \frac{1}{2 π fC} \qquad ( 4 )$$

where X_{C} is the resistance of the acoustic capacitance C to oscillations with frequency f, Pa·sec/m³,
f—oscillation frequency, Hz,
C—acoustic capacitance, m³/Pa.

The Helmholtz resonator pipe resistance with acoustic inductance L to oscillations with frequency f is equal to:

X_{L}=2πfL (5)

X_{L}—resistance of the acoustic inductance L to oscillations with frequency f, Pa·sec/m³,

f—oscillation frequency, Hz,

L—acoustic inductance, Pa·sec²/m³.

Unlike the electrical active resistance, the active resistance R of the Helmholtz resonator is not constant. It is common knowledge that the turbulent motion of the gas flow through the pipe results in a pressure drop at the ends of the pipe that is equal to:

$$Δ P = χ ρ A \frac{{v}^{2}}{2} = χ ρ \frac{1}{A} \frac{{q}^{2}}{2} \qquad ( 6 )$$

where ΔP is the pressure drop at the pipe ends, Pa,
χ—total of the pipe aerodynamic resistance coefficients: inlet, outlet, along the length and local, for example, turns,
ρ—gas density, kg/m³,
A—pipe transversal area, m²,
q—gas flow rate, m³.

Active resistance of the pipe is equal:

$$R = \frac{Δ P}{q} = χ ρ \frac{1}{2} \frac{q}{A} \qquad ( 7 )$$

where R is active resistance of the pipe, Pa·sec/m³,

ΔP—pressure drop at the pipe ends, Pa,
q—gas flow rate, m³/sec,
χ—total of the pipe aerodynamic resistance coefficients: inlet, outlet, along the length and local, for example, turns,
ρ—gas density, kg/m³,
A—pipe transversal area, m².

The Q-factor of the Helmholtz resonator is equal to:

$${Q}_{R} = \frac{{X}_{L}}{R} \qquad ( 8 )$$

where Q_{R} is the Q-factor of the Helmholtz resonator,

X_{L}—resistance of the pipe acoustic inductance L to oscillations with the resonant frequency f₀, Pa·sec/m³,

R—active resistance of the pipe, Pa·sec/m³.

At the resonant frequency, the Helmholtz resonator input resistance as well as the parallel oscillating circuit is equal to:

Z_{rez}=Q_{R}X_{L} (9)

where Z_{rez} is the Helmholtz resonator input resistance at the resonant frequency, Pa·sec/m³,
Q_{R}—Q-factor of the Helmholtz resonator,
X_{L}—resistance of the pipe acoustic inductance L to oscillations with the resonant frequency f₀, Pa·sec/m³.
The amplitude of pressure fluctuations in the chamber at the resonant frequency is equal to:

P_{REZ}=q_{A}Z_{rez} (10)

where P_{REZ} is the pressure fluctuations amplitude, Pa,
q_{A}—inlet flow rate fluctuations amplitude to the Helmholtz resonator, m³/sec,
Z_{rez}—Helmholtz resonator input resistance at the resonant frequency, Pa·sec/m³.
The flow rate fluctuations amplitude in the pipe at the resonant frequency is equal to:

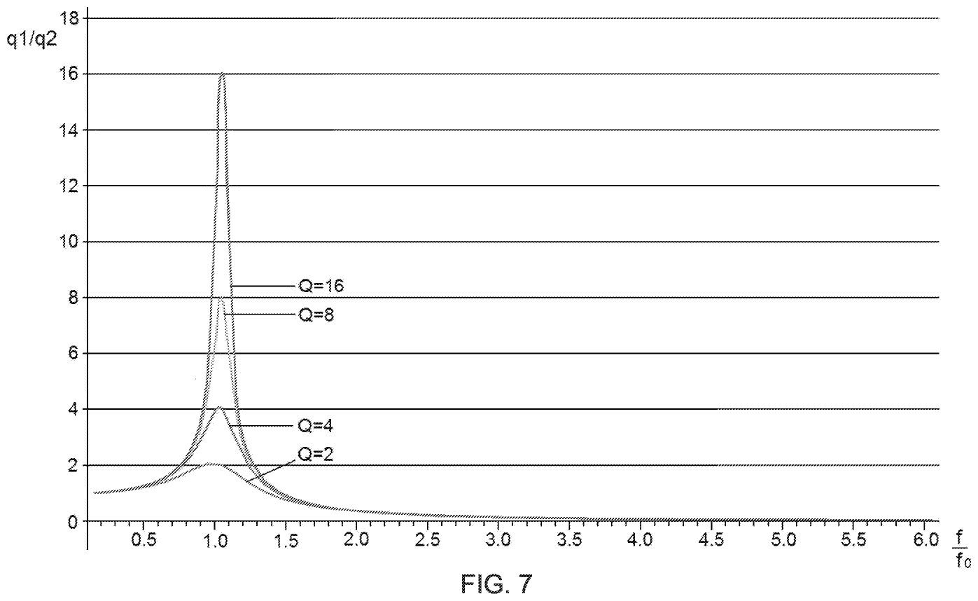

q_{L}=q_{A}Q_{R} (11)

where q_{L} is flow rate fluctuations amplitude in the Helmholtz resonator pipe, m³/sec,
q_{A}—inlet flow rate fluctuations amplitude to the Helmholtz resonator, m³/sec,
Q_{R}—Q-factor of the Helmholtz resonator.
The amplitude of pressure fluctuations in the Helmholtz chamber at random frequency is equal to:

$${P}_{f} = {P}_{R E Z} \frac{1}{\sqrt{1 + {{Q}_{R}^{2} ( \frac{{f}_{0}}{f} - \frac{f}{{f}_{0}} )}^{2}}} \qquad ( 12 )$$

where P_{f} is the pressure fluctuations amplitude in the Helmholtz resonator chamber at random frequency, Pa,
P_{REZ}—pressure fluctuations amplitude in the Helmholtz resonator chamber at the resonance frequency, Pa,
Q_{R}—Q-factor of the Helmholtz resonator,
f₀—resonant frequency, Hz,
f—oscillation frequency, Hz.
The flow rate fluctuations amplitude in the Helmholtz resonator pipe at the random frequency is equal to:

$${q}_{f} = \frac{{P}_{f}}{\sqrt{{R}^{2} + {X}_{L}^{2}}} = \frac{{P}_{f}}{\sqrt{{R}^{2} + {( 2 π fL )}^{2}}} \qquad ( 13 )$$

where q_{f} is the flow fluctuations amplitude in the Helmholtz resonator pipe at the frequency f, m³/sec,
P_{f}—pressure fluctuations amplitude in the Helmholtz resonator chamber at random frequency, Pa,
R—active resistance of the pipe, Pa·sec/m³,
X_{L}—resistance of the pipe acoustic inductance L to oscillations at the frequency f, Pa·sec/m³,
f—oscillation frequency, Hz,
L—acoustic inductance, Pa·sec/m³.
FIG. 7 shows the ratio of the amplitude q₂ of flow rate fluctuations in Helmholtz resonator pipes to the amplitude q₁ of flow rate fluctuations at the inlet to the Helmholtz resonator depending on the Q-factor Q_{R} of the Helmholtz resonator and ratio of flow rate fluctuations frequency to the natural frequency of the Helmholtz resonator.
It is commonly accepted to estimate the ratio of the flow rate fluctuations amplitude at the inlet to the flow rate fluctuations amplitude at the device outlet, in decibels. For this, the following formula is used:

$$K = 20 lg ( \frac{{q}_{1}}{{q}_{2}} ) \qquad ( 14 )$$

K—ratio of the gas flow fluctuations amplitude at the inlet to the amplitude of gas flow fluctuations at the device outlet, in decibels, dB.
q₁—flow rate fluctuations amplitude at the Helmholtz resonator inlet, m³/sec,
q₂—flow rate fluctuations amplitude at the Helmholtz resonator outlet, m³/sec.

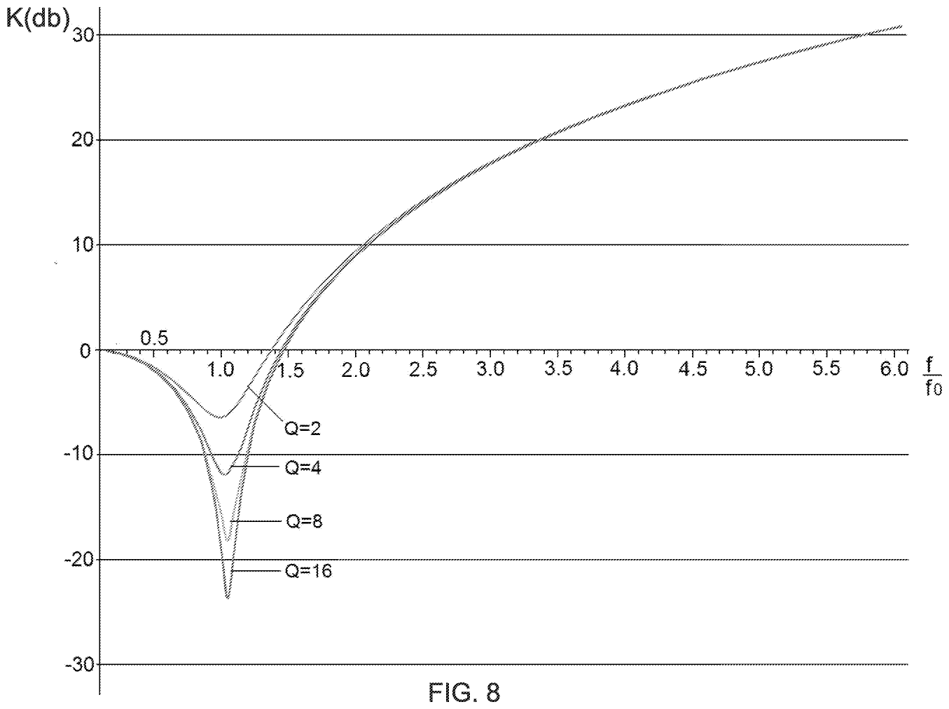

FIG. 8 shows the ratio K, in decibels, of the amplitude of flow rate fluctuations at the Helmholtz resonator inlet to the amplitude of flow rate fluctuations in the pipes, depending on the Q-factor Q_{R} of the Helmholtz resonator and the ratio of flow rate fluctuations frequency to the natural frequency of the Helmholtz resonator.

As we can see from the graphs, there is a frequency interval where the flow rate fluctuations amplitude in the resonator pipes is greater than the amplitude of flow rate fluctuations at the resonator inlet. When the flow rate fluctuations frequency exceeds the Helmholtz resonator natural frequency by 1.3-1.4 times, the flow rate fluctuations amplitude in the Helmholtz resonator pipes becomes lower than the flow rate fluctuations amplitude at the resonator inlet.

At the resonant frequency, the pressure fluctuations amplitude in the Helmholtz resonator chamber and the flow rate fluctuations amplitude in the Helmholtz resonator pipes depend on the Q-factor. The Q-factor should be increased in order to increase the amplitudes of the pressure resonant fluctuations in the chamber and the gas flow in the pipes. The Q-factor depends on the Helmholtz resonator pipes resistance. The pipe resistance should be lowered to increase the Q-factor. The pipe resistance is made up of inlet, outlet, length resistances and local resistances such as pipe bends, changes in pipe cross-section, installation of structural elements in the pipes or at the inlet or outlet, such as a filter screen. The pipe resistance at the inlet and outlet can be reduced by nozzles such as Board and/or Venturi. In pulsating combustion devices, the Helmholtz resonator pipes resistance reduction also allows to reduce the required pressure drop to flue gas outlet. The pipe resistance along the length can be decreased by using pipes with less roughness of the inner walls. Besides the pipe resistance, the Q-factor decreases when the gas pressure in the Helmholtz resonator chamber drops because of gas leaks.

The flue duct outlet of the Helmholtz resonator pipe must be directed into the atmosphere or a chamber, so that there is no resistance to fluctuations in the pipe gas flow. Otherwise, if a long pipe is connected to the Helmholtz resonator pipe outlet of the flue duct, the flue duct resonator loses its properties.

If there is an outlet for the gas flow in made as an opening or slit, or as a pipe with a length comparable to its diameter, then such a chamber is a low-pass filter. In order to explain the implemented technical solutions, the properties of low-pass filters will be used based on the analogy with electrical engineering, as the properties of a low-pass filter are well studied in electrical engineering.

Low-pass filters have a frequency-dependent effect on gas flow fluctuations. The low-pass filters have a cut-off frequency. The filters do not affect fluctuations with frequencies below the cut-off frequency and reduce the gas flow rate fluctuations amplitude with the frequencies above the cut-off frequency. The low-pass filter cut-off frequency is equal to:

$${f}_{0} = \frac{1}{2 π RC} \qquad ( 15 )$$

where f₀ is the low-pass filter cut-off frequency, Hz,
R—active resistance at the low-pass filter chamber output, Pa·sec/m³,
C—low-pass filter chamber acoustic capacitance, m³/Pa.

The high efficiency peculiar to pulsating combustion devices is the result of pulsations of the velocity (flow rate) of hot flue gases in the resonance pipes 2. When the velocity pulsations take place, the gas flow turbulence is greater than it is in a uniform motion. The flue gas turbulence mixes the flow and increases the contact between the flue gas flow and walls of the resonance pipes 2 that are part of the heat-exchange device of the pulsating combustion apparatus. It is most promising to increase the efficiency of heat transfer in the resonance pipes 2 as most of the heat energy is transferred in the resonance pipes 2.

Pursuant to the present invention, the improvement of the efficiency of pulsating combustion devices derives from increasing the flue gas flow rate fluctuations amplitude in the resonance pipes 2 at a given ratio of the heat transfer area to the area of the flow cross-section of the resonance pipes 2.

In order to increase the amplitude of fluctuations in the flue gas flow rate in the resonance pipes 2, the amplitude of pressure fluctuations in the combustion chamber 1 rises, and the amplitude of pressure fluctuations at the outlet of the resonance pipes 2 rises in the antiphase to the pressure fluctuations in the combustion chamber 1, which means that the amplitude of pressure drop between the input and output of the resonance pipes 2 of the pulsating combustion device rises.

In order for the device to operate, the flue gas flow rate fluctuations in the resonance pipes 2 at the outlet of the resonance pipes 2 must not be resisted. For this, the output of the resonance pipes 2 shall be diverted either into the atmosphere or directly into the flue chamber 5 of the Helmholtz resonator 3, or into the flue chamber 5 through an acoustic low-pass filter that comprises a chamber 34 and a coupling tube 35 and has a cut-off frequency higher than the combustion pulsation frequency.

The pressure fluctuations amplitude in the combustion chamber 1 depends on the Q-factor of the resonator arranged by the combustion chamber 1 and resonance pipes 2, and on the phase of the combustion initiation relative to the pressure phase in the combustion chamber 1 and the combustion period.

The Helmholtz resonator Q-factor based on the equation 8 demonstrates the relative loss of the resonator oscillational energy over the fluctuation period:

$${Q}_{R} = \frac{W}{Δ W} \qquad ( 16 )$$

where Q_{R} is the Q-factor of the Helmholtz resonator,
W—resonator oscillation energy at the beginning of period, W,
ΔW—fluctuation energy lost by the Helmholtz resonator over the period, W.

The pressure fluctuations amplitude in the combustion chamber 1 will not change if the fluctuations get an energy boost during the combustion, which will be equal to an energy loss of fluctuations over the period. In the resonator comprising the combustion chamber 1 and the resonance pipes 2, the Q-factor is always higher than 1, otherwise there are no resonator properties, so the oscillational energy is higher than the oscillational energy boosted due to the combustion. The increase in the Q-factor of the resonator comprising the combustion chamber 1 and resonance pipes 2 leads to an increase in the pressure fluctuations amplitude in the combustion chamber 1 and the amplitude of flue gas flow rate fluctuations in the resonance pipes 2, which, in turn, leads to increase in the efficiency of the pulsating combustion device heat exchange.

When the resonator created by the combustion chamber 1 and the resonance pipes 2 vibrates, the kinetic energy of the flow velocity in the resonance pipes 2 is converted into potential pressure energy in the combustion chamber 1 and in the flue chamber 5 and vice versa. The oscillational energy loss includes the loss of kinetic energy for the resonance pipes 2 resistance and the loss of the pressure potential energy in the combustion chamber 1 and in the flue chamber 5. The potential pressure energy loss takes place when the elevated, relatively average pressure decreases because of the flue gas leaks and when the reduced, relatively average pressure increases because of the flue gas inflow.

The less leakage of pressure oscillation energy from the first flue chamber 5, the more potential pressure energy of this flue chamber 5 will be converted back to the gas kinetic energy in the resonance pipes 2, the less will be the loss of oscillation energy of the pulsating combustion device operating resonator because of the leaks towards the flue gas release.

If there is no outlet to divert flue gases in the flue chamber 5, then all potential pressure energy in it will be converted back into the flow rate kinetic energy in the resonance pipes 2. In this case, the pressure fluctuations in the flue chamber 5 would be in antiphase to the pressure fluctuations in the combustion chamber 1, and the pressure fluctuations in the flue chamber 5 could be characterized by the following dependence:

$${P}_{1} = \frac{{V}_{0}}{{V}_{1}} {P}_{0} \qquad ( 17 )$$

where P₁ is the amplitude of pressure fluctuations in the flue chamber 5, Pa,
P₀—amplitude of pressure fluctuations in the combustion chamber 1, Pa,
V₀—volume of the combustion chamber 1, m³,
V₁—volume of the flue chamber 5 cavity, m³.

An increase in the flue chamber 5 volume leads to a decrease in the pressure in the flue chamber 5 relative to the pressure in the combustion chamber 1 which reduces the share of the potential energy of the pressure in the flue chamber 5 in the total potential energy of the resonator which reduces the possible loss of oscillation energy of the resonator due to pressure leaks in the flue chamber 5 towards the flue gases release.

The presence of the outlet in the flue chamber 5 leads to gas leaks towards the flue gas release and results to a loss of potential pressure energy in the flue chamber 5, which lowers the Q-factor of the Helmholtz resonator comprising the combustion chamber 1 and the resonance pipes 2. The number of leaks depends on the flue chamber 5 outlet type. If the outlet from the flue chamber 5 is made as an opening or a slot, then the flue chamber 5 is a flue duct low-pass filter. If the pipe 7 is installed at the flue chamber 5 outlet, then the flue chamber 5 with the pipe 7 form the first Helmholtz resonator of the flue channel.

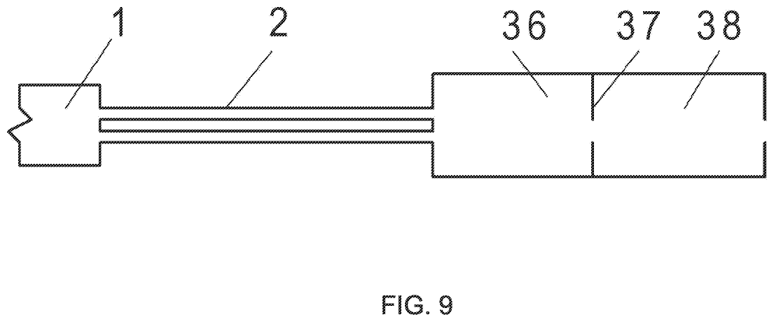

FIG. 9 shows the first low-pass filter of the flue duct created by a chamber 36 with an opening 37 at the resonance pipes 2 outlet. A low-pass acoustic filter with large active and small inductive resistances forms a resistance to flow fluctuations roughly equal to constant flow resistance. To significantly reduce the pressure leaks in the flue chamber 36 towards the flue gas release, the active resistance at the chamber 36 outlet should be large enough that would require a large pressure difference for flue gas release. This embodiment of the low-pass acoustic filter that avoids leaks significantly reduces the possible power level of the pulsating combustion device.

If the flue chamber 36 is connected to a next successively installed flue chamber 38 through a large active resistance as an opening 37 or a slit (not illustrated in the figure) with the cross-sectional area less than the total cross-sectional area of the resonance pipes 2, this reduces the possible power level of the pulsating combustion device. Conversely, when the flue chamber 36 is connected to the next successively installed flue chamber 38 through a small active resistance as the opening 37 or a slit (not illustrated in the figure) with the cross-sectional area greater than the aggregate cross-sectional area of the resonance pipes, the above two cavities of the specified two flue chambers 36 and 38 exhibit the property of one total volume cavity.

The most effective reduction of pressure leaks from the flue chamber toward the flue gas outlet is carried out by the flue chamber 5 with the flue duct 7 at the outlet which create the first Helmholtz resonator 3 of the flue duct. The lower the natural frequency of the Helmholtz resonator 3 of the flue duct, the less leaks as flow fluctuations it passes through.

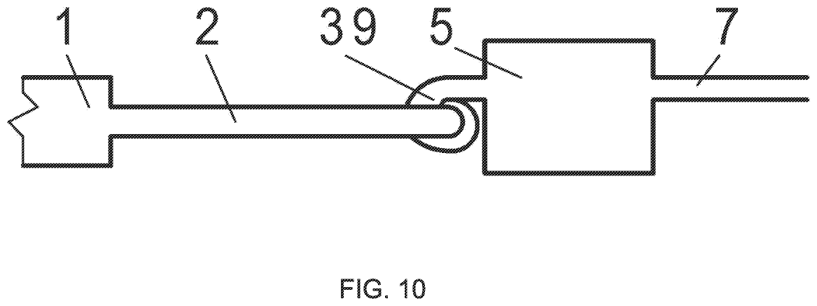

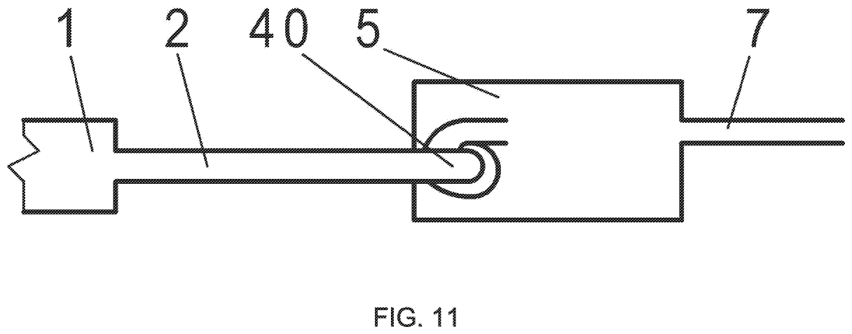

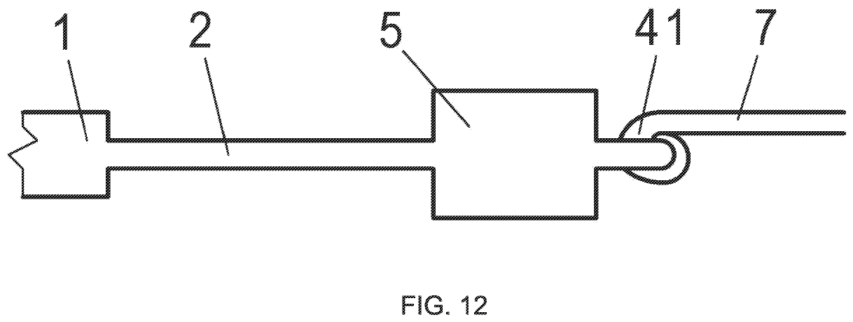

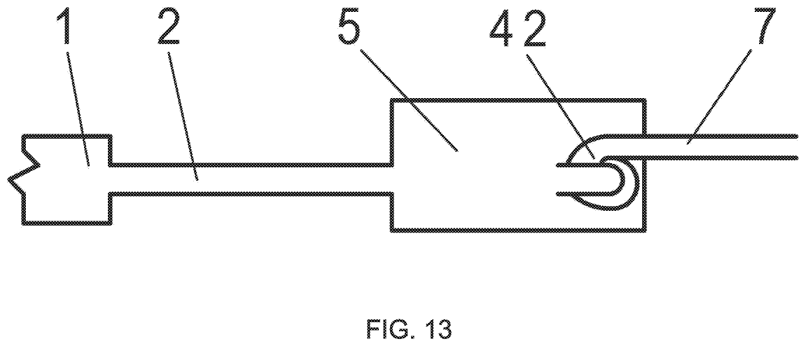

An inductance resonator, a device that has acoustic inductance, can be connected to the Helmholtz resonator 3, as shown in FIGS. 10-13. A device 39 outside the chamber 5 and a device 40 inside the chamber 5 that can be a turbine, fan, or a reversible device that can operate both as a fan and as a turbine are shown at the inlet of the Helmholtz resonator 3 flue chamber 5. A device 41 outside the chamber 5 and a device 42 inside the chamber 5 that can be a turbine, fan, or a reversible device that can operate both as a fan and as a turbine are shown at the outlet of the Helmholtz resonator 3 flue chamber 5.

A turbine or reversible device operating in the turbine mode, installed at the outlet of the flue chamber 5, is inertial. This enhances the total acoustic inductance of the pipe and turbine or reversible device compared to the pipe acoustic inductance reducing the operating oscillation energy loss. A pressure drop is required to create power on the shaft of a turbine or reversible device which leads to an increase in the overall pressure drop to the flue gas exhaust. The fan installed at the outlet of the combustion chamber 5 located after the resonance pipes 2 downstream the flue gas flow may or may not rotate during the pulsating combustion device operation. If the fan rotates, the acoustic inductance at the outlet of the flue chamber 5 rises, and it results in a reduction of the operating oscillation energy loss. Regardless of the fan rotation, the flue gas flow is resisted thus increasing the overall pressure drop for the flue gas venting.

A turbine or a reversible device operating in the turbine mode mounted at the inlet to the flue chamber 5, located after the resonance pipes 2 along the flue gas flow, is inertial. This increases the acoustic inductance of the resonance pipes 2, which leads to a decrease in the frequency of operating oscillations. The moment of inertia of the turbine or reversible device must be low because the speed of the turbine or reversible device must be variable with the operating fluctuations frequency. The operating oscillation energy is used to create power on the shaft of the turbine or reversible device.

The fan installed at the inlet of the combustion chamber 5 located after the resonance pipes 2 downstream the flue gas flow may or may not rotate during the pulsating combustion device operation. If the fan spins, the acoustic inductance of the resonance pipes 2 rises leading to a decrease in the operating frequency of the oscillations. The moment of inertia of the fan must be low because the speed of the fan must be variable with the operating fluctuations frequency. If the fan does not spin, then the flow of flue gases generates resistance, and the operating oscillations energy is spent to overcome this resistance.

The outlet of the flue chamber 5 as a long chimney 7 is the best way to increase the efficiency of the pulsating combustion device. These flue chamber 5 and flue pipe 7 make up the Helmholtz resonator 3 with its natural resonance frequency lower than the operating frequency of the Helmholtz resonator made up by the combustion chamber 1 and the resonance pipes 2. At the same time, the greater the ratio of the indicated combustion pulsation frequency to the natural frequency of the Helmholtz resonator 3 comprising the flue chamber 5 and the flue pipe 7, the higher the energy that locks the oscillations of the pulsed combustion device. In this case, the greatest blocking of oscillational energy in the pulsating combustion device and the prevention of penetration of flue gas flow rate fluctuations into the flue duct take place, and this, in turn, decreases the noise in the flue duct. Usually, the reduction of noise in the gas ducts leads to a decrease in the device efficiency caused by the backpressure of the gas flow, but the proposed design increases the efficiency of heat exchange of the pulsed combustion device and, therefore, improves the efficiency with a simultaneous reduction of noise in the flue duct.

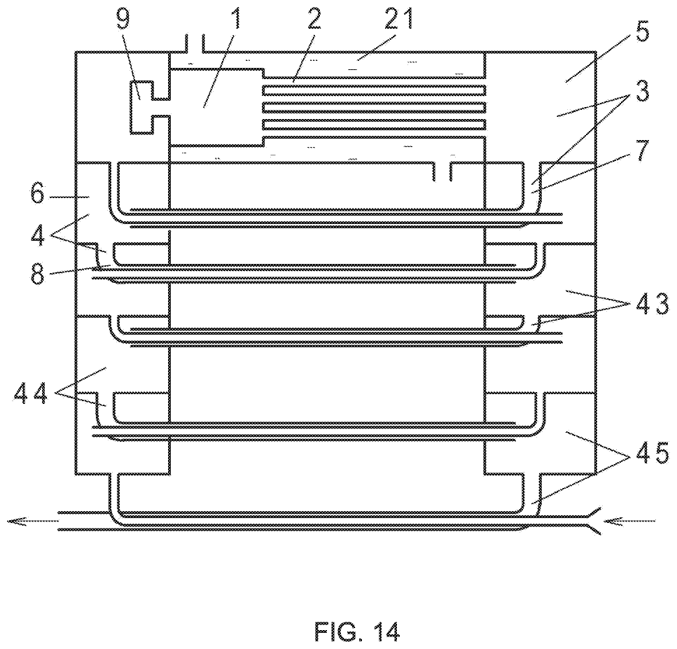

If another flue chamber 6 with a flue pipe 8 is installed successively along the flue gas flow, which also form the Helmholtz resonator 4, then the losses of gas pressure fluctuations from the first flue chamber 5 will be creating pressure fluctuations in the second flue chamber 6. These pressure fluctuations in the second flue chamber 6 will be a backpressure for losses from the first flue chamber 5, which will result in a reduction of losses from the first flue chamber 5. Moreover, the flue pipe 8 at the outlet of the second flue chamber 6 will lower the level of fluctuations in the flue gas flow, which will reduce the noise in the flue duct. As a result, the application of the second flue chamber 6 with the flue pipe 8 that form the second Helmholtz resonator 4 of the flue duct, and the use of subsequent Helmholtz resonators 43, 44 and 45 shown in FIG. 14, will improve the device efficiency and reduce noise in the flue duct. In order to achieve the maximum effect, several, preferably from three to five, Helmholtz resonators with the natural resonance frequency of 1.3-5 times less than the frequency of combustion pulsations are successively installed in the flue duct. When the frequency ratio is less than in 1.3 times, the Helmholtz resonators do not significantly reduce the operating oscillation energy loss. On the other hand, when the frequency ratio is more than in 5 times, the Helmholtz resonators have significant geometric dimensions and replacement of one such resonator by two ones more effectively reduces the energy losses of operating oscillations at a smaller size and material consumption.

The losses from the flue chamber 5 or 6 of the Helmholtz resonator 3 or 4 can be reduced (as shown in FIG. 1 for the Helmholtz resonator 3) by lowering the pressure fluctuations amplitude with the volume of the flue chamber 5 or 6 maintained. For this, a Helmholtz resonator 46 or a quarter-wave resonator (not illustrated) can be connected to the flue chamber 5 or 6, the natural frequency of the resonator should be equal to the combustion pulsation frequency. The Q-factor of the resonator 46 must be high. With the high Q-factor of the resonator 46 and a small difference in the natural frequency of the resonator 46 and the combustion pulsation frequency, the phase of the resonator 46 oscillations differs significantly from the phase of the pulsating combustion device, which significantly reduces the efficiency of the resonator 46. Normally the pulsating combustion device operates in a wide range of coolant temperatures which results in a significant range of flue gas temperatures and velocity of sound in the flue gases. In these conditions, the natural frequency of the resonator 46 changes. The application of the resonator 46 for decreasing the pressure fluctuations amplitude in the flue chamber 5 or 6 is limited to particular applications of the pulsating combustion device if the temperature operation of the pulsating combustion device is the same for most of the operating time in these applications. FIG. 1 shows connection of the Helmholtz resonator 46 to the flue chamber 5 in order to reduce the pressure oscillation amplitude in the flue chamber 5 and to reduce the leaks of pressure fluctuations to the flue pipe 7.

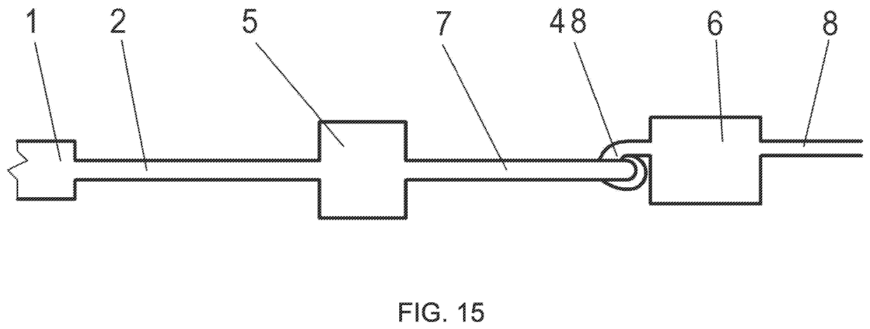

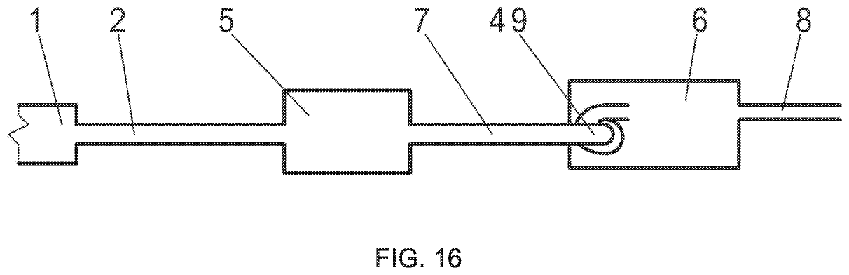

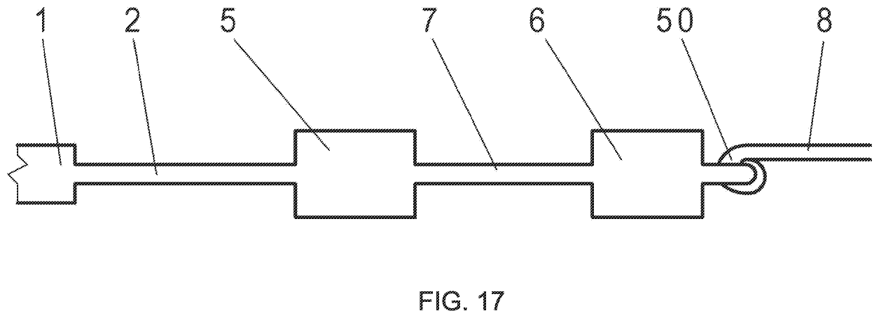

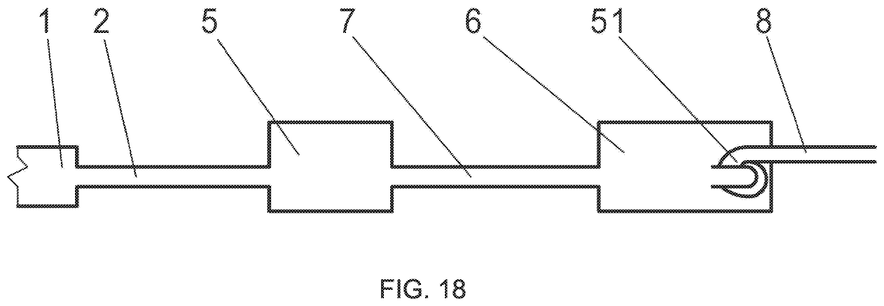

Inductive resistance, a device with acoustic inductance, can be connected to the Helmholtz resonator 4 and downstream Helmholtz resonators 43, 44, 45, as shown in FIGS. 15-18. A device 47 outside the chamber 6 and a device 48 inside the chamber 6 that can be a turbine, fan, or a reversible device that can operate both as a fan and as a turbine are shown at the inlet of the Helmholtz resonator 4 flue chamber 6. A device 49 outside the chamber 6 and a device 50 inside the chamber 6 that can be a turbine, fan, or a reversible device that can operate both as a fan and as a turbine are shown at the outlet of the Helmholtz resonator 4 flue chamber 6.

In some cases, components with active impedance, such as acoustic low-pass filters, can be installed in the flue or air supply duct. For example, an additional gas-gas type heat exchanger 33 as shown in FIG. 5, or, for example, a filter screen 51 can be installed at any location in the flue duct or at any location in the air duct to prevent debris and foreign items from entering the duct. FIG. 5 shows the heat exchanger 33 blown by the fan 32 that is installed in the section of the pipe 8 of the flue duct resonator 4. This element can be located between a flue chamber and a flue pipe of any Helmholtz resonator. In this case, the flue pipe acoustic inductance will remain unchanged, but the flue pipe impedance will increase. The natural resonance frequency of the Helmholtz resonator will remain unchanged, but the total pressure drop on the flue gas exhaust will increase.

FIG. 1 shows coupling of several resonance pipes 2 with the flue chamber 5. In the most preferred embodiment of pulsating combustion devices with multiple resonance pipes 2, these resonance pipes 2 are connected to the flue chamber 5 by a transition element 34 connected to the coupling pipe 35 with the cross-sectional area greater than the total cross-sectional area of the resonance pipes 2 for coupling to the flue chamber 5. In this case, the transition element 34 can be a chamber of small volume that, combined with said coupling pipe 35, makes up an acoustic low-pass filter with a cut-off frequency higher than the combustion pulsation frequency. That is why the resonance pipes 2 and the coupling pipe 35 make up a unified acoustic inductance.

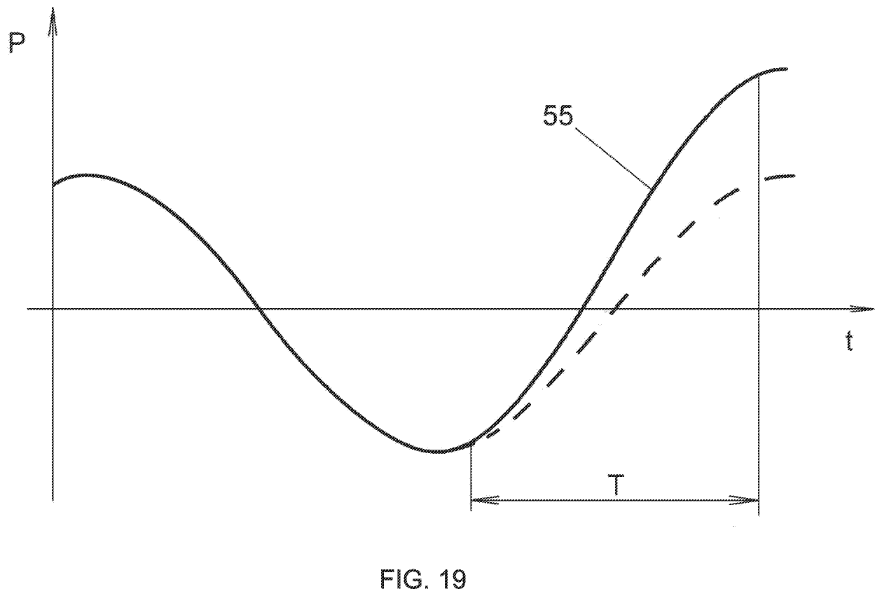

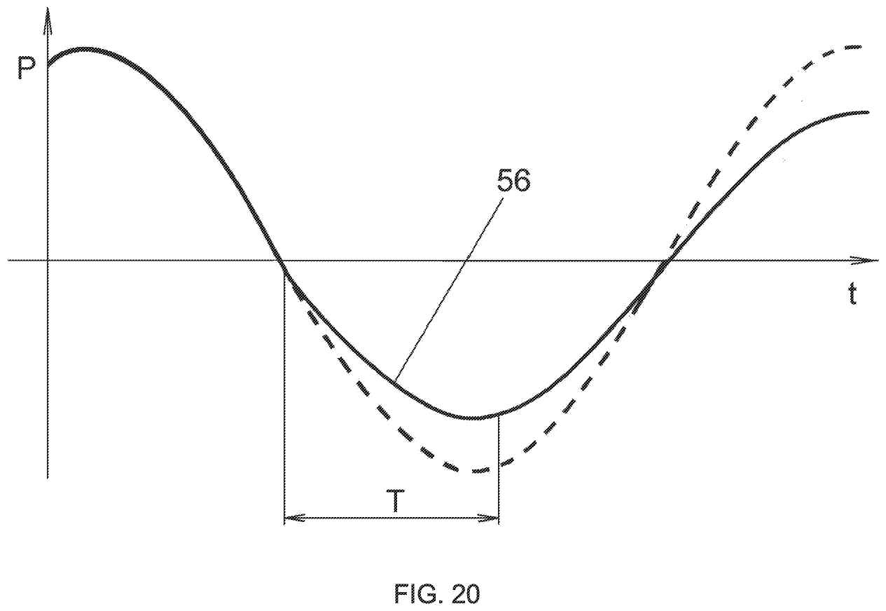

To improve the efficiency of the pulsating combustion device through the increase of oscillation energy, the leaks of the oscillation energy into the flue duct should be reduced and the phase of combustion should be optimized relative to the pressure fluctuations in the combustion chamber 1. If combustion takes place while the pressure in the combustion chamber 1 is increased, then the combustion raises the oscillation energy, and if the combustion takes place while the pressure in the combustion chamber 1 is decreased, then the combustion reduces the oscillation energy. FIG. 19 shows an increase and FIG. 20 shows a decrease in the oscillation energy as a function of the combustion phase, where the lines 55 and 56 show the change in pressure in the combustion chamber 1 in the time interval T.

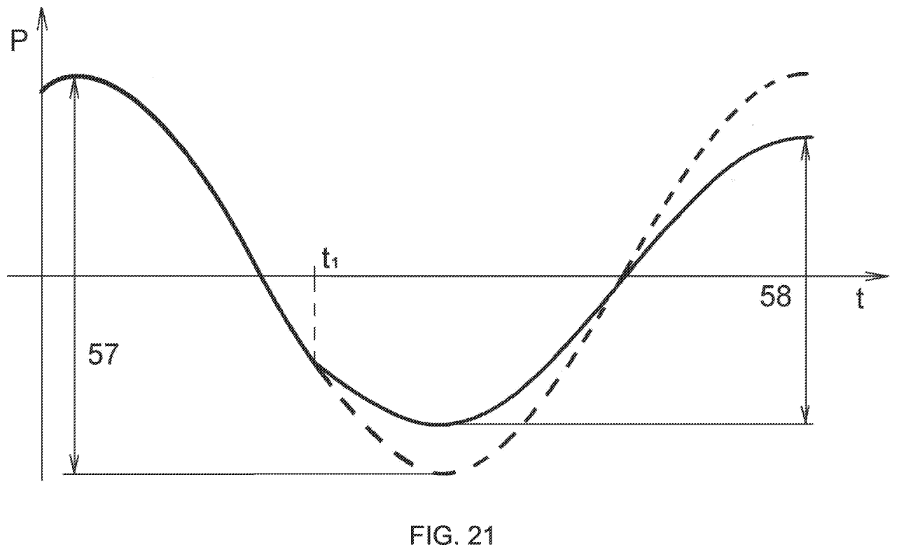

The supply of the preconditioned combustible mixture or air and combustible gas separately into the combustion chamber 1 is carried out by means of the reduced pressure in the combustion chamber 1, therefore the combustion always starts at the reduced pressure in the combustion chamber 1. When the combustion process takes place at a reduced pressure in the combustion chamber 1, the pressure in the combustion chamber 1 increases limiting the possible Q-factor of the resonator formed by the combustion chamber 1 and the resonance pipes 2, which constrains the minimum possible pressure in the combustion chamber 1 and, therefore, limits the pressure fluctuation amplitude in the combustion chamber 1. In FIG. 21, the combustion starts at the moment t₁, the line 57 illustrates the possible amplitude without combustion, and the line 58 demonstrates the limitation of the pressure fluctuation amplitude in the combustion chamber 1 by the combustion.

The combustion initiation at reduced pressure in the combustion chamber 1 reduces the oscillation energy, so the combustion time must ensure that the combustion ends at increased pressure in the combustion chamber 1 and the increase in the combustion energy at increased pressure in the combustion chamber 1 must be greater than the decrease in the combustion energy at decreased pressure in the combustion chamber 1. A small change in the combustion phase or combustion time causes a significant change in the combustion oscillation energy.

If the Q-factor of the Helmholtz resonator formed by the combustion chamber 1 and the resonance pipes 2, which is not limited by the combustion initiation, is considerably higher than the Q-factor of this resonator limited by the combustion initiation, then there arises the Q-factor reserve. This reserve of quality can be used to improve the heat transfer efficiency. When the volume of the flue chamber 5 cavity decreases, the amplitude of pressure fluctuations in the flue chamber 5 rises and the pressure loss grows, but only until there is a quality reserve, it does not lead to a decrease in the amplitude of pressure fluctuations in the combustion chamber 1. The increase in the amplitude of pressure fluctuations in the combustion chamber 5 with preservation of the amplitude of pressure fluctuations in the combustion chamber 1 leads to an increase in the amplitude of the flue gas velocity in the resonance pipes 2, which improves the heat exchange efficiency. It is preferred that the volume of the flue chamber 5 is 1 to 5 volumes of the combustion chamber 1, the length of the flue duct 7 at the outlet of the flue chamber 5 is equal to 20 to 80 internal diameters of the flue duct 7, and the cross-section of the flue duct 7 is ¼ to ¾ of the total cross-sections of the resonance pipes 2.

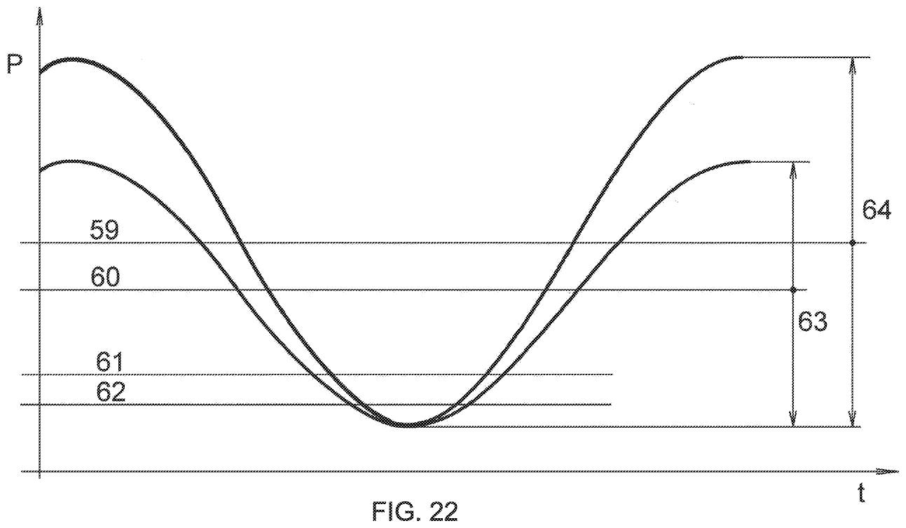

Since the combustion initiation depends on the time when the fuel gas is fed into the combustion chamber 1, delay in the fuel gas supply is made to increase the fluctuations amplitude. In order to delay the supply of fuel gas into the combustion chamber 1, the average pressure in the combustion chamber 1 is increased relative to the combustible gas pressure at the combustible gas check valve 10 by increasing the flue duct resistance. The effect of the average pressure in the combustion chamber 1 on the pressure fluctuations amplitude in the combustion chamber 1 is given in FIG. 22, where a line 59 indicates the higher average pressure in the combustion chamber 1 compared to an average pressure 60 in the combustion chamber 1, a line 61 indicates the pressure in the combustion chamber 1 when the combustible gas starts flowing into the combustion chamber 1, a line 62 indicates the pressure in the combustion chamber 1 at the combustion initiation, which limits the pressure fluctuations amplitude in the combustion chamber 1, pressure fluctuations amplitude 63 at an average pressure 60 is lower than pressure fluctuations amplitude 64 at the average pressure 59.

The increase in the pressure fluctuations amplitude is carried out when the average pressure in the combustion chamber 1 inevitably rises. With an increase in the average pressure in the combustion chamber 1, it is difficult to supply air into the combustion chamber 1, because the air is supplied through a reduced pressure drop.

In the air duct (as shown in FIGS. 1 and 2), there are resistances, such as the purge fan 18, the air supply pipe 12, the air check valve 9, and the filter screen, to feed air into the combustion chamber 1. With turbulent flow, the pressure drop across the resistance is proportional to the squared flow rate. The air is supplied to the combustion chamber 1 in half the period of operation oscillation, so the air supply to the combustion chamber 1 exceeds the average air flow by more than two times and requires a pressure drop of more than four times higher than at a uniform average flow rate. The air check valve 9 is installed in the cavity of the enclosure chamber 11 with the air supply pipe 12 with high inertial properties (high acoustic inductance) successively connected to ensure effective supply of the required amount of air. These enclosure chamber 11 and the pipe 12 make up the Helmholtz resonator 13 of the air duct that has its own resonant frequency.

The air keeps flowing in the air supply duct 12 at the enclosure chamber 11 of the valve 9 throughout the period of operating oscillations, which generates increased pressure in the enclosure chamber 11 by the time of the next opening of the air check valve 9 and start of air supply to the combustion chamber 1, which significantly improves the air flow to the combustion chamber 1.

In order to increase the air inflow stabilization by the Helmholtz resonator 13 of the air duct, the natural frequency of this resonator must be lower than the combustion pulsation frequency, this frequency is identical both for the flue gas and for the air, fuel gas or combustible mixture fed into the combustion chamber 1. The ratio of the combustion pulsation frequency to the natural frequency of the Helmholtz 13 resonator determines the degree of stabilization of the air inflow. The higher the frequency ratio, the greater the degree of air inflow stabilization. In order to achieve the air inflow stabilization degree close to constant, the resonator frequency needs to be very low, which requires a large volume of the enclosure chamber 11 and a long length of the pipe 12. With a long length of the air supply pipe 12, the inert properties of the pipe are impacted by the compressibility of the gas and the velocity of sound, which leads to a decrease in the actual inertness of the gas in the air supply pipe 12 relative to the calculated value and an increase in the actual frequency of the resonator 13 relative to the calculated value.

It is impossible to achieve the required stabilization of the air inflow with one resonator, therefore, several, preferably from three to five Helmholtz resonators are successively installed in the air duct, as shown in FIG. 14.

In the air duct, a chamber of the Helmholtz resonator 13 located the closest to the combustion chamber 1, is the enclosure chamber 11 of the air check valve 9, which can be made of metal or reinforced concrete. It is recommended to install a sound-absorbing material 14 on the inner (and/or outer) surfaces of the enclosure chamber 11 to suppress the reverberation generated by the repeated reflection of the shock wave from the inner surfaces of the enclosure chamber 11 of the air check valve 9.

As the results of the experiments indicate, it is preferable to have the volume of the Helmholtz resonator chambers in the air duct in the range from 0.5 to 5 volumes of the combustion chamber 1, the cross-sectional area of pipes in the air duct should be from 0.5 to 1.0 of the total cross-sectional area of the resonator pipes 2, the length of each pipe in the air duct should be from 20 to 50 of inner diameters of one pipe which correspond to the ratio of the operating air flow rate fluctuations frequency to the natural frequency of the resonator from 1.3 to 5.

The air duct pipes can be placed inside the flue duct pipes, as shown in FIG. 14, to improve the device efficiency. The exhaust flue gases will be heating the combustion air, the temperature of the exhaust flue gases will be decreasing, which will lower the heat loss with the discharge of flue gases and increase the efficiency of the device.

A significant increase in the pressure fluctuations amplitude in the combustion chamber 1 may require a significant increase in the average pressure in the combustion chamber 1, which will make it much more difficult to deliver the required amount of air to the combustion chamber 1. The difference between the average pressure in the combustion chamber 1 and the fuel gas pressure at the fuel gas check valve 10 can be saved and, at the same time, the average pressure in the combustion chamber 1 can be decreased by reducing the fuel gas pressure. For this purpose, the resistance between the fuel gas check valve 10 and the flue duct is increased and the resistance between the fuel gas check valve 10 and the duct between the fuel gas check valve 10 and the combustion chamber 1 is decreased.

When the fuel gas pressure in the enclosure chamber 15 of the fuel check valve 10 drops relative to the average pressure in combustion chamber 1, the supply of fuel gas to the combustion chamber 1 is carried out in a small portion of the reduced pressure in the combustion chamber 1, and a small deviation in the amplitude of the pressure fluctuations in the combustion chamber 1 can generate a large change in the portion of fuel gas fed into the combustion chamber 1, which makes the pressure fluctuations in the combustion chamber 1 predisposed to be unstable. In order to improve the stability of the pressure fluctuations in the combustion chamber 1 and, therefore, to increase the possible amplitude of the stable pressure fluctuations in the combustion chamber 1 between the fuel gas duct and the enclosure chamber 15 of the fuel gas check valve 10, the pipe 16 of FIG. 2 with high acoustic inductance, such as a pipe with a length of 10 to 30 inner diameters, and the volume of the enclosure chamber 15 is chosen, for example, from 0.05 to 0.5 volumes of the combustion chamber 1, so that variations in the portion of fuel gas fed into the combustion chamber 1 result in a significant change in pressure in the enclosure chamber 15. This makes the influx of fuel gas into the enclosure chamber 15 close to a constant value. The volume of the fuel gas that enters the combustion chamber 1 at the next period of pressure fluctuations in the combustion chamber 1, the pressure in the enclosure chamber 15 will change, and this, in turn, will compensate for the change in the volume of the next portion of gas by changing the pressure fluctuations amplitude in the combustion chamber 1. The stabilization of the fuel gas inflow into the enclosure chamber 15 of the fuel gas check valve 10 decreases the noise created by flow pulsations in the fuel gas duct. In order to create a significant reduction of the fuel gas pressure in the enclosure chamber 15, a significant resistance of the pipe 16 is required, which reduces the acoustic inductance effect on the fuel gas flow. Replacement of one chamber with a pipe by several consecutive chambers with pipes between the fuel gas check valve 10 and the fuel gas duct enhances the stabilization effect. The stabilization of the fuel gas portion that is fed into the combustion chamber 1 per period makes it possible to increase the amplitude of stable pressure fluctuations in the combustion chamber 1.

Besides, the increase in the pressure fluctuations amplitude in the combustion chamber 1 during the combustion process is impacted by the quality of fuel-air mixture agitation.

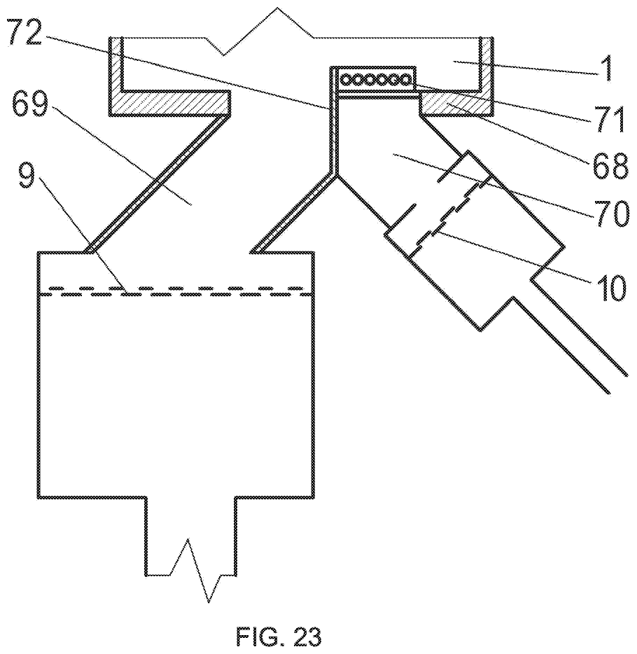

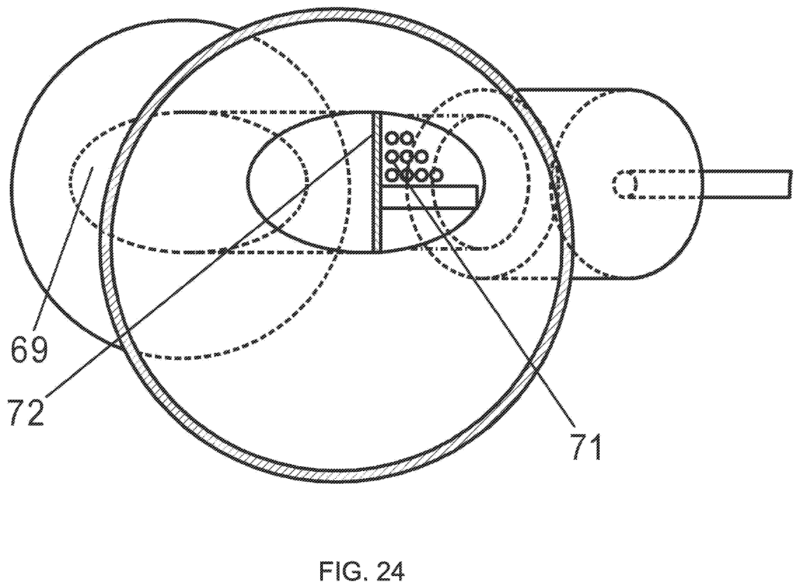

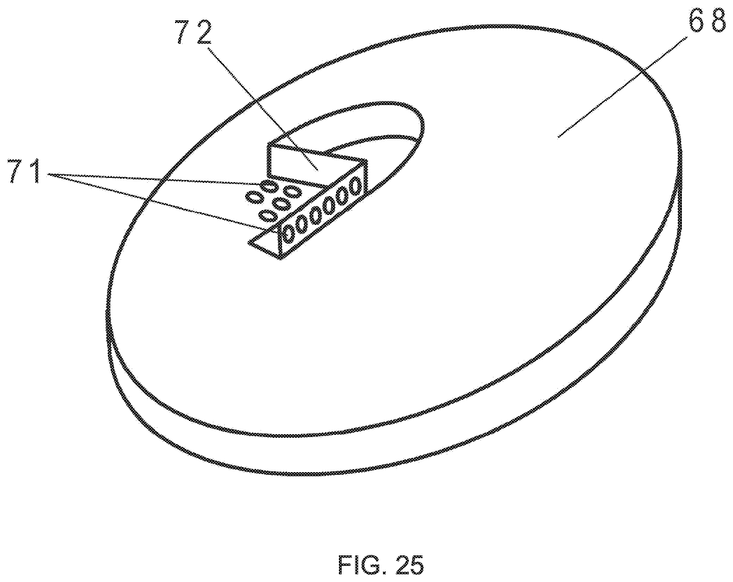

FIGS. 23-25 illustrate the assembly for preparing a combustible mixture with a partition for turbulence when air and fuel gas are fed separately into the combustion chamber 1 through an end wall 68 of the combustion chamber 1. The air check valve 9 and the fuel gas check valve 10 are connected to the combustion chamber 1 by means of the first 69 and the second 70 branch pipes, respectively. The axis of the first branch pipe 69 is angled to the end wall 68 of the combustion chamber 1 and inclined towards the second branch pipe 70. The second branch pipe 70 is connected to the combustion chamber 1 through openings 71 and/or slots. At the outlet of the first branch pipe 69, there is a partition 72 that separates the outlet of the first branch pipe 69 from the outlet of the second branch pipe 70.

The air from the air check valve 9 flows through the channel of the first branch pipe 69 into the combustion chamber 1 close to the end wall 68 of the combustion chamber 1. A poorly streamlined partition 72 located in the airflow route produces turbulent airflow. The fuel gas flows into the combustion chamber 1 from the fuel gas check valve 10 through the duct of the second branch pipe 70 through the openings 71, where it is mixed with the air. The distance between the air inlet and the gas inlet in the combustion chamber 1 and the proximity of the end wall 68 of the combustion chamber 1 causes a delay in the formation of the combustible mixture, which delays the combustion initiation. The turbulence of the air flow ensures that the gas and air agitation is such that there is sufficient combustion time to keep the oscillation amplitude high and the fuel gas burns completely with low harmful emissions.

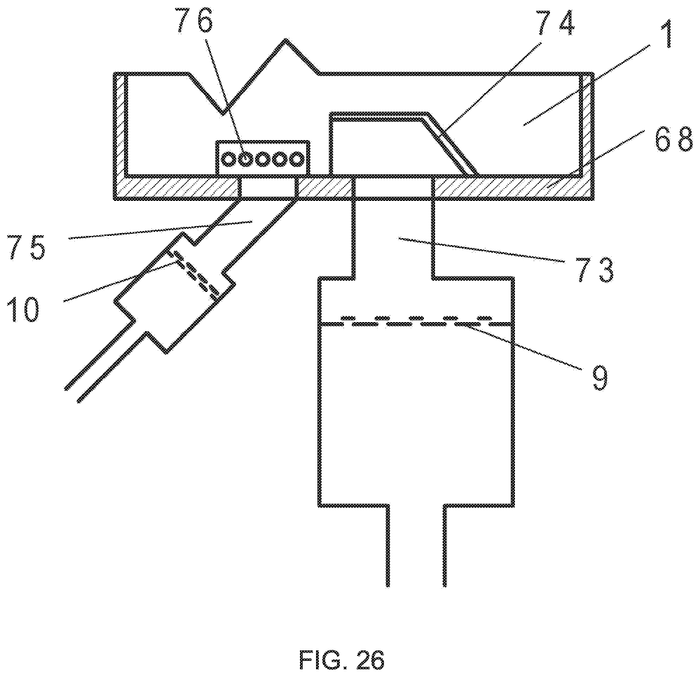

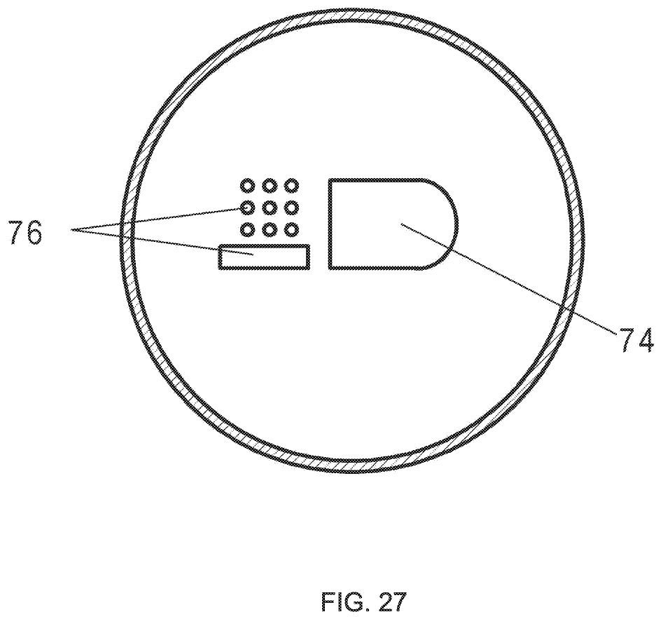

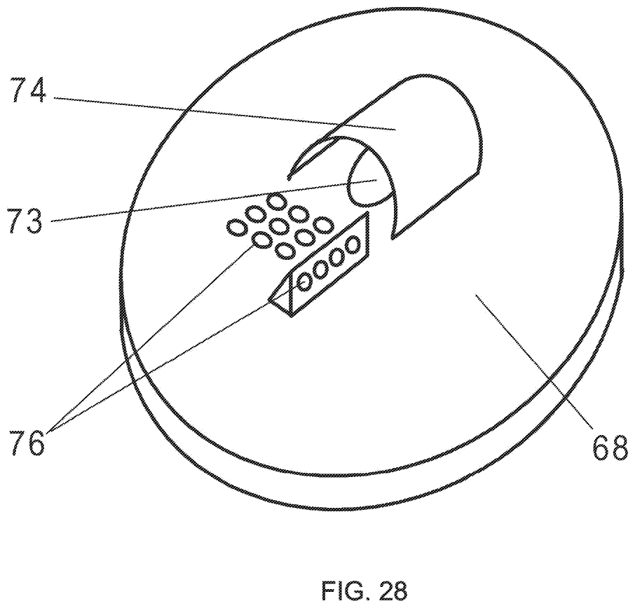

FIGS. 26-28 illustrate the assembly for preparing a combustible mixture with a guide element when air and fuel gas are fed separately into the combustion chamber 1 through the end wall 68 of the combustion chamber 1. The air check valve 9 is connected to the combustion chamber 1 through the third branch pipe 73 at the outlet of which there is a guide element 74 in the combustion chamber 1 designed to divert the air flow along the wall 68 of the combustion chamber 1. The fuel gas check valve 10 is connected to the combustion chamber 1 by a fourth branch pipe 75 connected to the combustion chamber 1 through openings 76 and/or slots located along the air flow from the guide element 74.

The air is fed to the combustion chamber 1 from the air check valve 9 through the third branch pipe 73 duct. The guide element 74 generates air flow turbulence and turns the air flow toward the end wall 68 of the combustion chamber 1. The combustible gas flows into the combustion chamber 1 from the flue gas check valve 10 through the duct of the fourth branch pipe 75 through the openings 76, where it is mixed with the air. The distance between the air inlet and the gas inlet in the combustion chamber 1 and the proximity of the end wall 68 of the combustion chamber 1 causes a delay in the formation of the combustible mixture, which delays the combustion initiation. The turbulence of the air flow ensures that the gas and air agitation is such that there is sufficient combustion time to keep the oscillation amplitude high and the combustion gas burns completely with low harmful emissions.

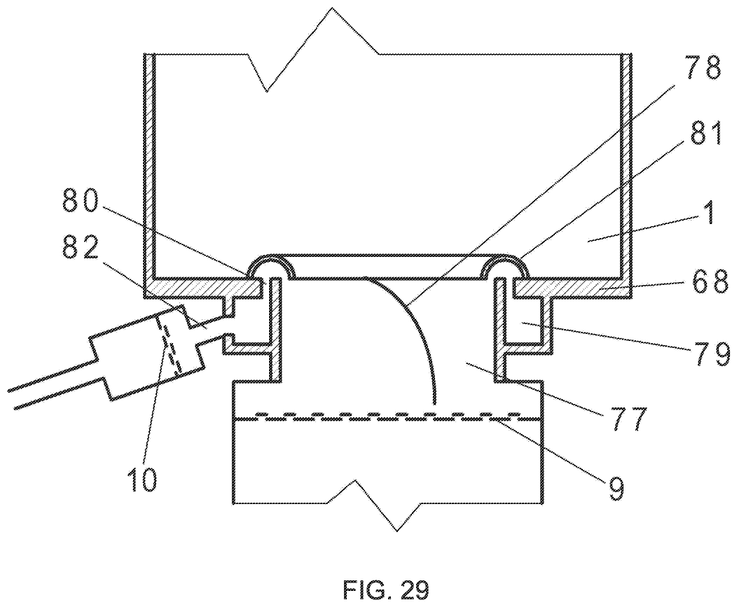

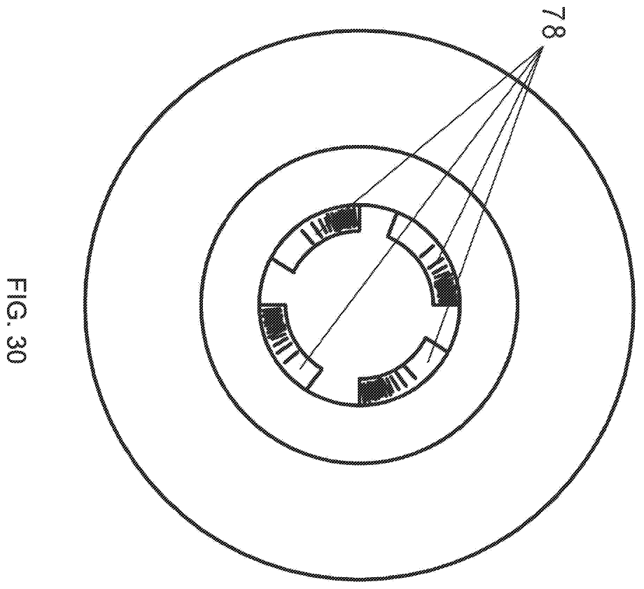

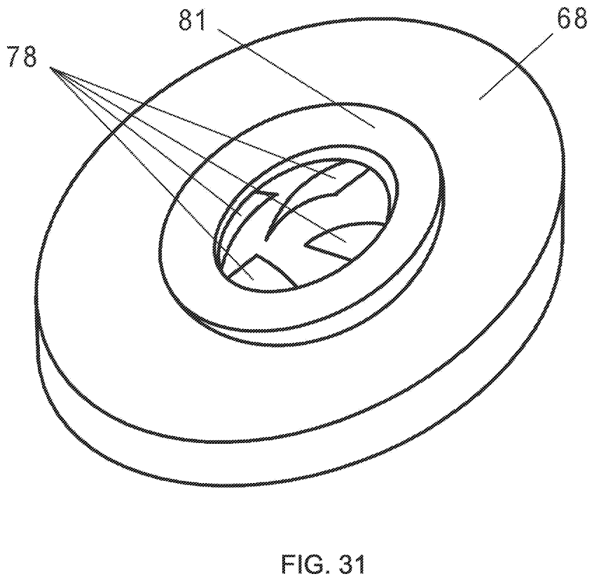

FIGS. 29-31 illustrate the assembly for preparing a combustible mixture with blades when air and fuel gas are fed separately into the combustion chamber 1 through the end wall 68 of the combustion chamber 1. The air check valve 9 is connected to the combustion chamber 1 through the fifth branch pipe 77 where at least one blade 78 is installed at the outlet to the combustion chamber 1, the blade partially overlaps the duct of the fifth branch pipe 77. The fifth branch pipe 77 is enclosed by an annular fuel gas chamber 79 connected to the combustion chamber 1 by an annular slot 80 and to the fuel gas check valve 10. At the outlet of the annular slot 80, there is a guide element 81 that directs the combustible gas to the outlet of the fifth branch pipe 77 against the air flow.

The air is fed to the combustion chamber 1 from the air check valve 9 through the fifth branch pipe 77 duct. The blades 78 generate air flow turbulence and provide most of the air flow with a rotary motion close to the end wall 68 of the combustion chamber 1. The fuel gas flows into the combustion chamber 1 from the fuel gas check valve 10 through the duct of the branch pipe 82 through the annular slot 80, where it is mixed with the air. The distance between the air inlet and the gas inlet in the combustion chamber 1 and the proximity of the end wall 68 of the combustion chamber 1 causes a delay in the formation of the combustible mixture, which delays the combustion initiation. Also, the guide element 81 is installed to delay the combustion initiation. The turbulence of the air flow ensures that the gas and air agitation is such that there is sufficient combustion time to keep the oscillation amplitude high and the combustion gas burns completely with low harmful emissions.

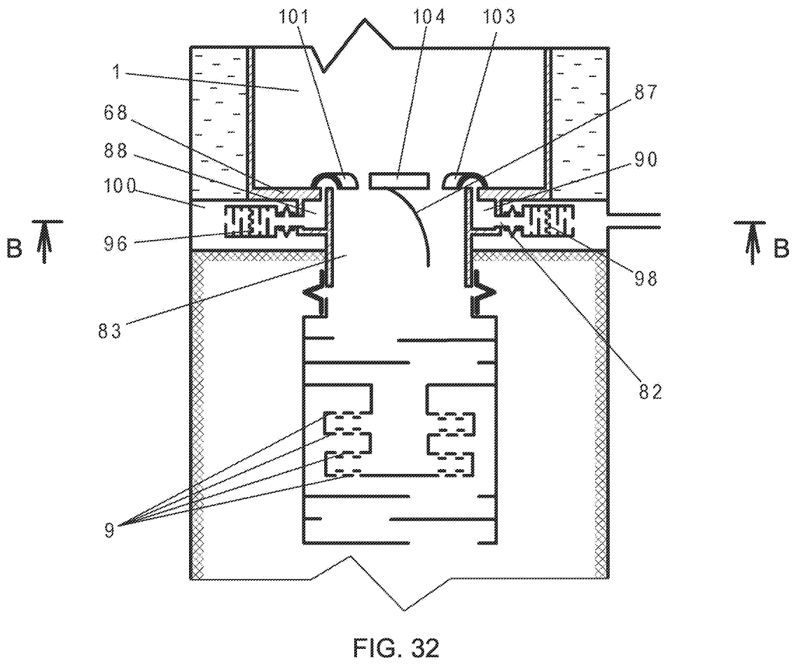

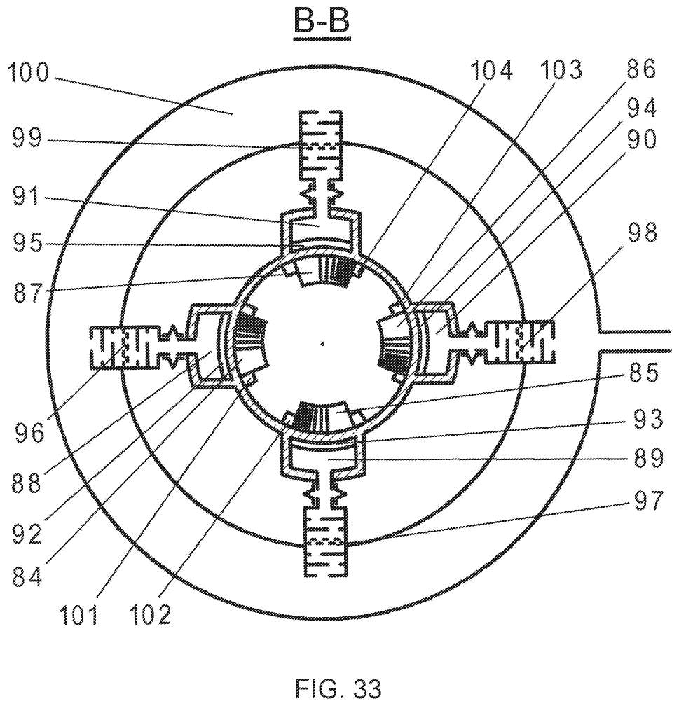

FIGS. 32-33 illustrate the assembly for preparing a combustible mixture with blades when air and combustible gas are fed separately into the combustion chamber 1 through the end wall 68 of the combustion chamber 1. Fuel gas and air can be fed into the combustion chamber 1 through one or more check valves. For example, FIGS. 32 and 33 demonstrate an assembly for preparing a combustible mixture when air and fuel gas are fed separately into the combustion chamber 1, where fuel gas enters the combustion chamber 1 through four check valves and the air is also fed through four check valves. The air check valves 9 are connected to the combustion chamber 1 by means of the sixth branch pipe 83 where four blades 84, 85, 86 87 are installed at the outlet to the combustion chamber 1, the blades partially block the duct of the sixth branch pipe 83. Four transition chambers 88, 89, 90, 91 of small volume, which are connected to the combustion chamber 1 by means of the slits 92, 93, 94, 95 and connected to the fuel gas check valves 96, 97, 98, 99 that are installed in the enclosure chamber 100, adjoin the sixth branch pipe 83. There are guide elements 101, 102, 103, 104 installed at the outlet of the slots 92, 93, 94, 95, the slots divert fuel gas to the outlet of the branch pipe 83 against the air flow.

The air is fed to the combustion chamber 1 from the air check valve 9 through the sixth branch pipe 83 duct. The blades 84, 85, 86 87 generate air flow turbulence and provide most of the air flow with a rotary motion close to the end wall 68 of the combustion chamber 1. Fuel gas from the enclosure chamber 100 is fed into the combustion chamber 1 from the fuel gas check valves 96, 97, 98, 99 by the transition chambers 88, 89, 90, 91 through the slots 92, 93, 94, 95, where it mixes with air. The distance between the air inlet and the gas inlet in the combustion chamber 1 and the proximity of the end wall 68 of the combustion chamber 1 causes a delay in the formation of the combustible mixture, which delays the combustion initiation. Also, the guide elements 101, 102, 103, 104 are installed to delay the combustion initiation. The turbulence of the air flow ensures that the gas and air agitation is such that there is sufficient combustion time to keep the oscillation amplitude high and the combustion gas burns completely with low harmful emissions.

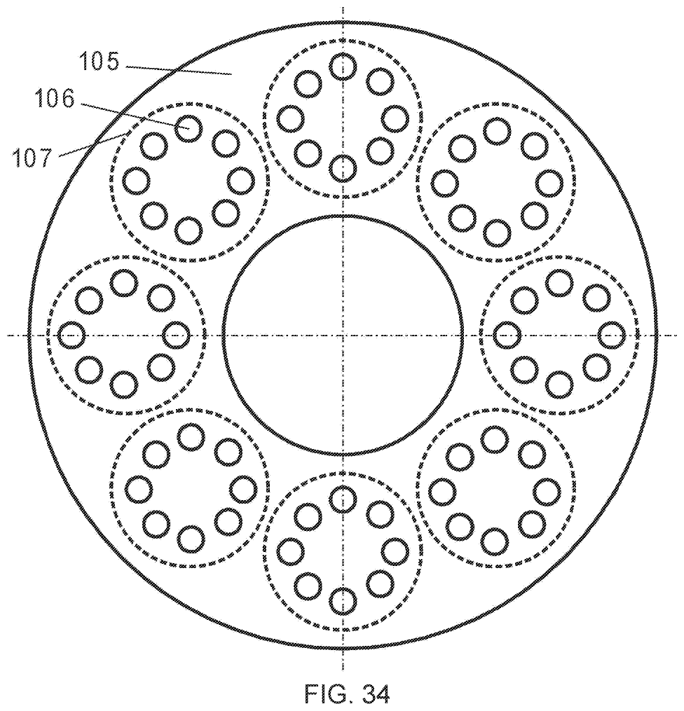

The units for preparing the combustible mixture, shown in FIG. 23-33, enable to implement the proposed improvement of the pulsating combustion device efficiency. For this purpose, the gas media check valves must provide high tightness in the closed state in the units for preparing the combustible mixture. It is advisable to use mechanical check valves of gaseous media. High tightness of mechanical check valves in the closed state is provided by diaphragms of small diameter up to 100 mm with width from 5 mm to 15 mm and diameter of through openings in the check valve plate not more than half the membrane width. FIG. 34 shows a gas media check valve plate 105 with through openings 106 and a membrane contact area 107.

The operation of pulsating combustion devices is characterized by fluctuations in the gas flow rate. The gas flow rate fluctuations are a source of noise. Besides, when pulsating combustion devices are operated by gas media check valves, a steep front of change in velocity and pressure of the gas flow is created, which, by its properties, is similar to a shock wave. Further, this phenomenon is described by the wording “shock wave”. The shock wave is a source of high intensity noise and oscillation. Therefore, apart from the noise caused by gas flow rate fluctuations, the pulsating combustion device generates extra noise and vibration from the shock wave.

The shock wave is generated by a check valve. When the mechanical check valve is closed, the diaphragms are shifted from the valve open position to the valve closed position by the reverse gas flow. The moment the membranes reach the valve closed position, the gas flow quickly, almost instantaneously, stops producing a water-hammer effect in the gas, which is similar to a water-hammer effect when a hydraulic check valve closes. Simultaneously, there is a pressure rise on one side of the mechanical check valve and a pressure drop on the other side of the valve. The valve is affected in a manner similar to a solid object impact, and in the gas medium, a shock wave, a source of high-intensity noise and oscillation, propagates to either side of the check valve.

The shock wave has high energy, lasts a short time and has a short front. At each operating period of gas flow fluctuations, the shock wave is generated. The time of shock wave formation and its transient processes is many times shorter than the gas flow oscillation operating period. Therefore each individual shock wave acts like a single impact.

To reduce the shock wave impact, at the inlet and/or outlet of the air check valve 9, a shock wave damper can be installed (FIG. 2). The shock wave dampers may be acoustic low-pass filters 108 including small chambers 109 with non-coaxial inputs and outputs and connected successively by openings 110 and/or slots, or the shockwave dampers are Helmholtz resonators 111 that include small chambers 112 with non-coaxial inputs and outputs and connected successively by pipes 113 with a diameter comparable with a length. At the same time, the acoustic low-pass filter 108 with the cut-off frequency higher than the combustion pulsation frequency is chosen, and the natural frequency of said Helmholtz resonator 111 is also chosen higher than the combustion pulsation frequency. Moreover, the shock wave damper can be designed as a curved section of pipe 114 that forms a bend in the duct, or as a solid sheet 115 installed with a gap relative to the duct walls, or as a perforated sheet 116, or as a metal-coal sheet 117 installed in the shockwave propagation line.

The air check valve 9 with shock wave dampers as acoustic filters 108 of low frequencies or shock wave dampers as the Helmholtz resonators 86 is installed on the combustion chamber 1 along with the application of vibration isolator 118.

At the inlet and/or outlet of the fuel gas check valve 10, shock wave dampers as acoustic filters 119 of low frequencies, which are small chambers 120 similar to the chambers of the acoustic filter 108, may also be installed, such dampers comprise non-coaxial inputs and outputs and connected by the openings 121, and/or slots, or shock wave dampeners as the Helmholtz resonators 122 including small chambers 123 with non-coaxial inputs and outputs and connected successively by the pipes 124 with a diameter comparable to a length. The fuel gas check valve 10 with acoustic filters 119 of low frequencies or Helmholtz resonators 122 is installed on the combustion chamber 1 along with the vibration isolator 125. When the oscillation isolation coefficient is high, the design of the check valves 9, 10 with installed acoustic filters 108, 119 of low frequencies or Helmholtz resonators 111, 122 may need additional measures to secure in the required position in space, such as the installation of extra elastic elements 126, 127.

The experiments conducted have tested different types of mufflers such as a chamber with a pipe embedded in this chamber cavity. The embedded part of the pipe had openings on the cylindrical part, the total cross-section of the openings is at least equal to the cross-section of the pipe, the options with open and plugged end of the pipe have been tested. Such mufflers block leaks less and generate more back pressure to exhaust flue gases. Another type of mufflers was tested as several successive chambers of different volume with a single solid pipe with openings on the cylindrical surface, the openings were grouped separately in each chamber.

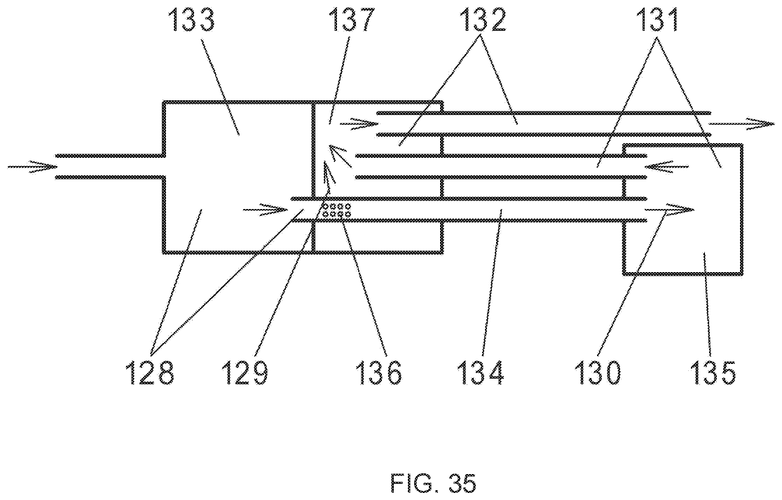

Moreover, the type of mufflers shown in FIG. 35 was tested, wherein a Helmholtz resonator 128 has two directions 129, 130 of flue gas flow exhaust, one of which flows into a next downstream Helmholtz resonator 131 and the other bypasses the next downstream Helmholtz resonator 131 into a third downstream Helmholtz resonator 132. The Helmholtz resonator formed by a chamber 133 and a pipe 134 has a flue gas flow discharge into a chamber 135 and discharge of a part of the flue gas flow into a chamber 137 through openings 136, while the main flue gas flow goes to the chamber 135 from the chamber 133 through the pipe 134. The specified types of mufflers have shown less efficiency compared to Helmholtz resonators located successively.

In order to increase the efficiency of heat transfer and reduce the noise level, vibration level, the combustion chamber, resonance pipes, Helmholtz resonators of air, flue ducts can be located in the coolant vessel. In this case, the resonators of air and flue ducts can be designed as separate elements or can be made in a single enclosure, as a single unit with multiple resonators.

For the 32 kW pulsating combustion device, the following optimal values were determined as a result of an experiment. Sixteen resonance pipes 2 are connected to the combustion chamber 1 (FIG. 1). The resonance pipes 2 are connected to the small transition chamber 34 as a truncated cone with a base diameter of 115 mm, diameter of the top 32 mm, height 30 mm. The transition chamber 34 is connected to the first flue chamber 5 pipe 35 with an inner diameter of 32 mm and a length of 30 mm. The actual combustion pulsation frequency of the pulsating combustion device is 60 Hz. The first flue chamber 5 with the first flue pipe 7 form the first Helmholtz resonator 3 of the flue duct with its natural resonance frequency of 13 Hz. Four Helmholtz resonators with natural resonance frequencies from 20 Hz to 27 Hz are successively connected to the first Helmholtz resonator 3 of the flue duct.

At the inlet and outlet of the air check valve 9, five acoustic filters 108 of low frequencies (FIG. 2) are installed, the filters are made as successively connected small chambers 84, each with an inner diameter of 125 mm, height 15 mm, each with end walls with non-axial openings 110 at inputs and outputs. In addition, the cross-sectional area of the openings in each of these walls is 1962.5 mm². The air check valve 9 with lower frequency acoustic filters 108 installed is connected to the inlet of the combustion chamber 1 with the help of the vibration isolator 118, and, in turn, the chamber of the first Helmholtz resonator 13 of the air duct is the enclosure chamber 11 of the air check valve 9 with lower frequency acoustic filters 108 installed on it. The inner walls of the enclosure chamber 11 of the air valve 9 are covered with sound-absorbing material 14. The first air chamber 11 is connected to the first air pipe 12, together they constitute the Helmholtz resonator 13 with the natural frequency of 40 Hz. Four Helmholtz resonators with natural frequencies from 25 Hz to 27 Hz are successively connected to the first Helmholtz resonator 13 of the air duct. There is a fan 18 inside the air chamber of the air duct fifth resonator. The fuel gas check valve 10 is installed with acoustic filters 119 of low frequencies, in a way similar to the air check valve 9. Each acoustic low-pass filter includes the chamber 95 with an inner diameter of 26 mm and a height of 7 mm, each chamber 95 has end walls with misaligned inlets and outlets 96. In addition, the cross-sectional area of the openings 121 in each of these walls is 8 mm². The fuel gas check valve 10 with acoustic filters 94 of low frequencies is connected to the inlet of the combustion chamber 1 along with the vibration isolator 125. The fuel gas check valve 10 with acoustic filters 119 of low frequencies installed is placed in the enclosure chamber 15. This enclosure chamber 15 is connected to the gas pipe 16 with an inner diameter of 8 mm and a length of 500 mm. The pipes of the air duct resonators are located inside the pipes of the flue duct resonators.

This embodiment with a power of 32 kW provides the following levels of harmful emissions: carbon monoxide CO—not more than 60 ppm, nitrogen oxides NOx—not more than 18 ppm. The noise level measured under no reverberation conditions at a distance of 1 m was 44.3 dBA.

The table shows the test data for 32 kW pulsating combustion device, with a coolant inlet temperature of 40° C. and an air inlet temperature of 18° C. Two Helmholtz resonators are installed in the air duct. Two Helmholtz resonators with the same natural resonance frequency are installed in the flue duct. The pipes of the air duct resonators are located inside the pipes of the flue duct resonators. The readings were taken when the temperature conditions were stabilized.

TABLE

| | The ratio of the operating | |
|---|---|---|
| | fluctuation frequency of the flue | |
| Helmholtz resonators | gas flow rate to the natural | |
| natural resonance | resonance frequency of the | Flue gas |
| frequency | Helmholtz resonator | temperature |
| Without resonators | | 48.9° C. |
| 45 Hz | 1.33 | 48.7° C. |
| 35 Hz | 1.71 | 48.0° C. |
| 30 Hz | 2.0 | 47.5° C. |
| 28 Hz | 2.15 | 47.1° C. |
| 27 Hz | 2.22 | 46.8° C. |
| 20 Hz | 3.0 | 45.5° C. |
| 12 Hz | 5.0 | 45.7° C. |
| 10 Hz | 6.0 | 45.2° C. |

The data presented in the table indicate that when the natural frequency of the Helmholtz resonators decreases, the temperature of the flue gases decreases, in other words, the efficiency of the pulsating combustion device increases.

1-35. (canceled)

36. A pulsating combustion device comprising a combustion chamber and, connected thereto, an air and fuel gas supply unit and a flue duct, said flue duct comprising at least one resonance pipe connected to the combustion chamber and at least two Helmholtz resonators located successively downstream of the at least one resonance pipe, each of said resonators comprising a flue chamber and a flue pipe arranged downstream thereof, and natural resonance frequency of each of the Helmholtz resonators is less than combustion pulsation frequency.

37. The device according to claim 36, wherein there are at least three said Helmholtz resonators of which at least one Helmholtz resonator is connected to the flue chamber of the third downstream Helmholtz resonator by means of a second flue pipe bypassing the next downstream Helmholtz resonator.

38. The device according to claim 36, wherein at least one resonance pipe is connected to the first Helmholtz resonator through a low-pass acoustic filter having a cut-off frequency higher than the combustion pulsation frequency.

39. The device according to claim 36, wherein an element with resistive and/or inductive impedance to gas flow is installed in the flue channel upstream or downstream of the flue chamber of at least one Helmholtz resonator.

40. The device according to claim 39, wherein the element with inductive impedance is a turbine, or a fan, or a reversible device that can operate both as a fan and as a turbine.

41. The device according to claim 36, wherein the air and fuel gas supply unit has at least one check valve.

42. The device according to claim 41, wherein the air and fuel gas supply unit includes at least one air check valve connected to an air duct and at least one combustible gas check valve connected to a fuel gas duct.

43. The device according to claim 42, wherein the air duct includes at least one enclosure chamber with the at least one air check valve inside and an air supply pipe connected to the enclosure chamber forming a first air duct Helmholtz resonator.

44. The device according to claim 43, wherein walls of the enclosure chamber of the at least one air check valve are coated with sound-absorbing material on the inside and/or outside.

45. The device according to claim 43, wherein the air duct comprises additionally at least one successively connected Helmholtz resonator having natural resonance frequency less than the combustion pulsation frequency.

46. The device according to claim 45, wherein the pipes of the air duct Helmholtz resonators are located inside the pipes of the flue duct Helmholtz resonators.

47. The device according to claim 36, wherein the Helmholtz resonators of the flue and air ducts are located in the same housing.

48-50. (canceled)
